(19) United States
(12) Patent Application Publication
(10) Pub. No.: US 2026/0050120 A1
(43) Pub. Date: Feb. 19, 2026

(54) COMPOSITE CONFINEMENT APPARATUS ASSEMBLY INCLUDING PHOTONICS APPARATUS AND CONFINEMENT APPARATUS

(71) Applicant: Quantinuum LLC, Broomfield, CO (US)

(72) Inventors: Adam Jay Ollanik, Boulder, CO (US); Rezlind Bushati, Rockville, MD (US); Daniel Ouellette, Minneapolis, MN (US); David Gaudiosi, Loveland, CO (US); Amit Agrawal, Gaithersburg, MD (US); Henri Joseph Lezec, Gaithersburg, MD (US); Wenqi Zhu, Gaithersburg, MD (US)

(21) Appl. No.: 19/302,894

(22) Filed: Aug. 18, 2025

Related U.S. Application Data
(60) Provisional application No. 63/684,752, filed on Aug. 19, 2024.

(51) Int. Cl. G02B 6/136

(52) U.S. Cl. CPC G02B 6/136

(57) ABSTRACT

A method of fabricating a photonics apparatus for a composite confinement apparatus assembly is provided. The method includes segmenting a spacer substrate to form a plurality of spacer structures and bonding the plurality of spacer structures to a photonic platform substrate.

### CROSS-REFERENCE TO RELATED APPLICATIONS

This application claims priority to U.S. Provisional Patent Application Ser. No. 63/684,752 , filed on Aug. 19, 2024, which is incorporated herein by reference in its entirety.

### STATEMENT REGARDING FEDERALLY SPONSORED RESEARCH

This invention was made with United States Government support from the National Institute of Standards and Technology (NIST), an agency of the United States Department of Commerce, under Collaborative Research and Development Agreement CN-21-0096. The Government has certain rights in this invention.

### TECHNICAL FIELD

Various embodiments relate to composite confinement apparatus assemblies that include photonics apparatuses and confinement apparatuses. An example embodiment relates to a method of manufacturing a photonics apparatus configured for being secured to a confinement apparatus.

### BACKGROUND

When using an ion trap to perform quantum computing, gates and other functions of the quantum computer are performed by applying laser beams to ions contained within the ion trap. Delivering these laser beams to a large-scale quantum computer is a significant challenge due to the low ion height above the trap, the Rayleigh range of the laser beams, and the amount of laser power that needs to be delivered to an ion within the trap to perform the functions of the quantum computer. Through applied effort, ingenuity, and innovation many deficiencies of prior laser beam application techniques have been solved by developing solutions that are structured in accordance with the embodiments of the present invention, many examples of which are described in detail herein.

### BRIEF SUMMARY OF EXAMPLE EMBODIMENTS

Example embodiments provide composite confinement apparatus assemblies or systems comprising composite confinement apparatus assemblies, and methods for fabricating photonics apparatus or composite confinement apparatus assemblies that include photonics apparatus. In various embodiments, a method of fabricating a photonics apparatus for a composite confinement apparatus assembly includes segmenting a spacer substrate to form a plurality of spacer structures; and bonding the plurality of spacer structures to a photonic platform substrate.

In an example embodiment, the method further includes fabricating one or more photonics components on and/or in the photonic platform substrate.

In an example embodiment, the plurality of spacer structures is bonded to a confinement apparatus-facing surface of the photonic platform substrate.

In an example embodiment, the plurality of spacer structures comprise three spacer structures extending from the confinement apparatus-facing surface of the photonic platform substrate.

In an example embodiment, the photonic platform substrate and the spacer substrate comprise same material.

In an example embodiment, the photonic platform substrate and the spacer substrate each comprise glass material.

In an example embodiment, the photonic platform substrate and the spacer substrate comprise different materials.

In an example embodiment, the photonic platform substrate comprises glass material and the spacer substrate comprises silicon material.

In an example embodiment, the photonic platform substrate comprises a transparent material.

In an example embodiment, bonding the plurality of spacer structures to the photonic platform substrate comprises performing at least one of optical bonding, silicate bonding, fusion bonding, anodic bonding, additive deposition of the plurality of spacer structures to the photonic platform substrate, adhesive bonding, solder bonding, diffusion bonding, eutectic bonding, or metal/metal bonding.

In an example embodiment, the spacer substrate comprises a pre-qualified spacer substrate having one or more of (i) a thickness within a predetermined thickness range or (ii) a thickness uniformity within a predetermined thickness uniformity range.

In an example embodiment, the photonic platform substrate comprises a pre-qualified photonic platform substrate having one or more of (i) a thickness within a predetermined thickness range or (ii) a thickness uniformity within a predetermined thickness uniformity range.

In various embodiments, a method of fabricating a photonics apparatus for a composite confinement apparatus assembly includes etching a photonic platform substrate to form a photonic platform and a plurality of spacer structures extending from the photonic platform, wherein: the plurality of spacer structures are configured for being secured to a confinement apparatus substrate, and each spacer structure of the plurality of spacer structures has a thickness that is substantially equal to a distance between a confinement apparatus-facing surface of the photonic platform and the confinement apparatus substrate.

In an example embodiment, the method further includes fabricating one or more photonics components on and/or in the photonic platform substrate.

In an example embodiment, the plurality of spacer structures comprise three spacer structures extending from the confinement apparatus-facing surface of the photonic platform substrate.

In an example embodiment, etching the photonic platform substrate to form the photonic platform and the plurality of spacer structures comprises performing a femtosecond laser-assisted etching.

In an example embodiment, etching the photonic platform substrate to form the photonic platform and the plurality of spacer structures comprises etching via fluid jet polishing.

In an example embodiment, the photonic platform substrate comprises silicon dioxide substrate.

In an example embodiment, the photonic platform substrate comprises a transparent material.

In various embodiments, a method of fabricating a photonics apparatus for a composite confinement apparatus assembly includes depositing one or more optical components on and/or at a photonic platform substrate; etching a spacer substrate to define a plurality of spacer structures; securing the photonic platform substrate to the plurality of spacer structures; and securing the photonic platform substrate to a confinement apparatus via the plurality of spacer structures.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example quantum computing system comprising a composite confinement apparatus assembly in accordance with an example embodiment of the present disclosure.

FIG. 2 is a schematic cross section view of a portion of a composite confinement apparatus assembly in accordance with an example embodiment of the present disclosure.

FIG. 3A provides a schematic side cross section view of a photonics apparatus in accordance with an example embodiment of the present disclosure.

FIG. 3B provides a schematic bottom cross section view of a photonics apparatus in accordance with an example embodiment of the present disclosure.

FIG. 4A provides a flowchart illustrating various processes, procedures, and/or operations for fabrication of a photonics apparatus in accordance with an example embodiment of the present disclosure.

FIG. 4B provides a flowchart illustrating various processes, procedures, and/or operations for fabrication of optical components on a photonic platform in accordance with an example embodiment of the present disclosure.

FIGS. 5A-5D provide cross section views of various stages of fabricating a photonics apparatus in accordance with the example embodiment of FIGS. 4A-B.

FIG. 6 provides a flowchart illustrating various processes, procedures, and/or operations for fabrication of a photonics apparatus in accordance with an example embodiment of the present disclosure.

FIGS. 7A-7B provide cross section views of various stages of fabricating a photonics apparatus in accordance with the example embodiment of FIG. 6.

FIG. 8 provides a flowchart illustrating various processes, procedures, and/or operations for fabrication of a photonics apparatus in accordance with an example embodiment of the present disclosure.

FIGS. 9A-9K provide cross section views of various stages of fabricating a photonics apparatus in accordance with the example embodiment of FIG. 8.

FIG. 10 provides a schematic diagram of an example controller of a quantum computer configured to control operation of a quantum processor in accordance with various embodiments of the present disclosure.

FIG. 11 provides a schematic diagram of an example computing entity of a quantum computing system that may be used in accordance with an example embodiment of the present disclosure.

### DETAILED DESCRIPTION OF SOME EXAMPLE EMBODIMENTS

The present invention now will be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

In various embodiments, a composite confinement apparatus assembly includes a confinement apparatus and at least a portion of a signal management system. For example, in various embodiments, a composite confinement apparatus assembly comprises a confinement apparatus substrate having a confinement apparatus formed thereon. For example, electrical components that form and/or define the confinement apparatus are disposed and/or formed on the confinement apparatus substrate. The electrical components include electrodes configured for defining confinement regions within which quantum objects may be confined. The composite confinement apparatus assembly further comprises a photonics apparatus. In various embodiments, the photonics apparatus is part of a signal management system configured to control and/or provide photonic beams and/or pulses provided to one or more object locations. The object locations are defined, at least in part, by the confinement apparatus. For example, the photonics apparatus includes optical components that may be used to control and/or provide photonic beams and/or pulses provided to the one or more object locations. In various embodiments, the photonics apparatus includes a photonic platform and a spacer structure (e.g., legs, spacer structures, nano-positioner mounting systems, and/or the like) for coupling and/or securing the photonic platform to the confinement apparatus substrate.

In various embodiments, the confinement apparatus is configured to confine a plurality of quantum objects at respective object locations defined at least in part by the confinement apparatus. The confinement apparatus is further configured to transport respective quantum objects between respective object locations. The signal management system is configured to provide select manipulation signals (e.g., laser beams, laser pulses, microwave beams or pulses, and/or the like) to particular object locations.

In an example embodiment, the confinement apparatus substrate further includes one or more optical components that are disposed and/or formed thereon and/or therein. In various embodiments, the one or more optical components are configured to provide respective manipulation signals to respective object locations defined within the confinement regions of the confinement apparatus and/or to receive/detect respective optical signals emitted by respective quantum objects located at respective object locations. For example, the one or more optical components disposed and/or formed on the confinement apparatus substrate are part of the signal manipulation system. In various embodiments, the one or more optical elements include passive and/or active optical elements. In an example embodiment, active optical elements include photodetectors such as photodiode, photomultiplier, charge-coupled (CCD) sensor, complementary metal oxide semiconductor (CMOS), Micro-Electro-Mechanical Systems (MEMS) sensor, and/or other photodetector. In various embodiments, the confinement apparatus is embodied as a confinement apparatus chip. In various embodiments, the photonics apparatus is embodied as a photonics apparatus chip.

In various embodiments, the confinement apparatus chip defines a plurality and/or an array of object locations. For example, the confinement apparatus chip may be configured such that when appropriate voltage signals are applied to electrical components (e.g., electrodes) thereof, an electric potential is generated that is configured to confine quantum objects at respective object locations. In various embodiments, a sub-array of object locations may be configured for performing a particular function (e.g., a reading function, performance of a single qubit or multi-qubit (e.g., two qubit) gate, and/or the like. In various embodiments, the optical components disposed on the confinement apparatus substrate, and/or photonic components disposed on the photonic platform that are configured for performance of the particular function are arrayed on their respective substrates accordingly.

In various embodiments, the confinement apparatus is an ion trap, such as a surface ion trap, Paul ion trap, and/or the like. Various other embodiments may include various other confinement apparatuses (e.g., optical trap and/or the like). In various embodiments, the quantum objects are neutral or ionic atoms; neutral, ionic, or multipole molecules; quantum particles; quantum dots; and/or other objects configured to be confined by the confinement apparatus and having quantum states that can be manipulated and/or controlled.

In various embodiments, the signal management system is configured to generate, provide, and/or control parameters (e.g., wavelength, intensity, phase, polarization, and/or the like) of electromagnetic signals applied to one or more object locations defined at least in part by the confinement apparatus for the purpose of controlling the quantum state of one or more quantum objects confined by the confinement apparatus. In various embodiments, the signal management system comprises photonic components that are part of the photonic platform. The signal management system may also include one or more optical components formed on the confinement apparatus substrate, in various embodiments. The photonic components and/or optical components may include active and/or passive optical elements respectively configured for generating, providing, collecting/detecting, and/or controlling parameters of manipulation signals applied to various object locations and/or collected from various object locations defined by the confinement apparatus. In an example embodiment, active optical elements include photodetectors such as photodiode, photomultiplier, charge-coupled (CCD) sensor, complementary metal oxide semiconductor (CMOS), Micro-Electro-Mechanical Systems (MEMS) sensor, and/or other photodetector. In various embodiments, the photonic components and/or optical components of the signal management system comprise flat optics (e.g., metasurfaces, diffractive optical elements, guided mode photonics (e.g., waveguides), microfabricated lenses, and/or the like. For example, in various embodiments, the photonic components and/or optical components of the signal management system comprise one or more diffractive optical elements (DOEs), passive metasurfaces, active metasurfaces, optical modulators, low loss waveguides, amplifiers, on-chip lasers, photodetectors, grating couplers, beam splitters, edge couplers, optical local oscillators, tapers, reference cavities, optical sinks, light absorbing structures, anti-reflection coatings, optical routing elements, resonant structures, and/or the like. In various embodiments, various photonic components and/or optical components of the signal management system have electronic components associated therewith (e.g., the optical elements may be active optical elements with electrically controlled aspects) and other photonic components and/or optical components of the signal management system do not have electronic components associated therewith (e.g., the optical elements may be passive optical elements and/or active elements controlled via a technique other than electric signal-based control).

In various embodiments, the confinement apparatus and/or confinement apparatus substrate define an apparatus plane. In various embodiments, the photonic platform defines a platform plane. In various embodiments, the platform plane is parallel to the apparatus plane but not coplanar with the apparatus plane. For example, the platform plane and the apparatus plane are separated by a set distance. A confinement apparatus volume is defined between the confinement apparatus substrate and the photonic platform. The confinement regions generated through the operation of the electrical components of the confinement apparatus (which are formed on the confinement apparatus substrate) generate confinement regions that are disposed within the confinement apparatus volume defined between the confinement apparatus and the photonic platform. For example, the object locations defined at least in part by the confinement apparatus are within the confinement apparatus volume defined between the confinement apparatus and the photonic platform.

In various embodiments, the composite confinement apparatus assembly is disposed within the action region of a cryogenic and/or vacuum chamber and configured to be operated under cryogenic and/or ultra-high vacuum conditions. For example, the composite confinement apparatus assembly is configured to be operated at temperatures at or less than 124 K and/or pressures at or less than 10⁻⁶ Pa.

In various embodiments, a composite confinement apparatus assembly is part of a QCCD-based quantum system comprising a confinement apparatus configured for confining quantum objects and a signal management system. In various embodiments, the signal management system includes the photonic platform and may include one or more optical components disposed on the confinement apparatus substrate. In various embodiments, respective composite confinement apparatus assemblies are part of various quantum and/or atomic systems (e.g., atomic clocks, quantum clocks, and/or other systems that include confined quantum objects).

Conventionally, laser beams are provided to positions within an ion trap through the use of external lasers and free space optics configured to provide the laser beams to specific positions within the ion trap. However, the amount of space required for such beam paths, even to provide laser beams to a relatively small number of defined positions of the ion trap, is significant (e.g., a few square meters). Additionally, the accuracy with which the laser beams may be provided to the positions within the ion trap through such conventional means can limit the density of the defined positions of ion trap. Moreover, ion traps are generally utilized within a cryogenic and/or vacuum chamber. As such, the laser beams must be passed through the cryogenic and/or vacuum chamber and any radiation and/or thermal shields therein. Thus, a technical problem exists as to how to provide manipulation signals to a quantum object confinement apparatus that is able to scale with the size and/or dimensions of the quantum object confinement apparatus efficiently and accurately. These technical problems are compounded as the quantum object confinement apparatus is increased in size (e.g., as the number of positions or object locations defined for the quantum object confinement apparatus increases).

Various embodiments provide technical solutions to these technical problems. In particular, in various embodiments, optical elements of the signal management system are incorporated and/or integrated into a composite confinement apparatus assembly. For example, one or more optical elements of the signal management system are disposed within the cryogenic and/or vacuum chamber. For example, the one or more optical elements of the signal management system include photonic components that are part of a photonic platform that is coupled and/or secured into relation with the confinement apparatus and/or confinement apparatus substrate. In some embodiments, the one or more optical elements of the signal management system include optical components disposed on the confinement apparatus substrate. These one or more optical elements include passive and/or active optical elements configured to control various parameters of respective manipulation signals and accurately direct respective manipulation signals to respective object locations. The optical elements may include one or more active optical elements that include photodetectors such as photodiode, photomultiplier, charge-coupled (CCD) sensor, complementary metal oxide semiconductor (CMOS), Micro-Electro-Mechanical Systems (MEMS) sensor, and/or other photodetector. In various embodiments, the use of the photonics apparatus (e.g., photonic platform thereof) reduces the spatial requirements for free space optics beam path configurations, number of cryogenic and/or vacuum chamber pass throughs, and/or the like. Furthermore, the configuration of the composite confinement apparatus assembly of various embodiments reduces the additional technical problems of signal management systems of larger confinement apparatuses. For example, the photonics apparatus is scalable with the confinement apparatus such that the signal management system is configurable for accommodating various numbers and/or arrangements/layouts of object locations. Thus, various embodiments provide technical solutions to technical problems regarding how to provide manipulation signals to an array of object locations defined at least in part by a confinement apparatus such that the manipulation signals are efficiently and effectively provided to the object locations, even when the object locations form a two or three-dimensional array.

Moreover, the photonic platform needs to be precisely spaced from the surface of the confinement apparatus and have a high degree of thickness uniformity and planarity, which otherwise can result in tilted photonic platform and result in wrong angle of direction of the beams from the photonic platform. Moreover, the inventors have found that certain fabrication methods may result in strain and warping. Various embodiments provide technical solutions to these technical problems by compositely or monolithically fabricating a photonics apparatus comprising a photonic platform and spacer structures that define the distance between the photonic platform and the surface of the confinement apparatus. For example, various embodiments form the photonic platform and the spacer structures monolithically from a single material. As another example, various embodiments form or otherwise pattern the spacer structures before securing to the photonic platform. In this regard, by forming the photonic platform and the spacer structures from a single material, various embodiments advantageously provide for matching of thermal expansion coefficients. Further by compositely or monolithically forming the photonic platform and the spacer structures, various embodiments avoid the risk of stress during release etch with bonded dissimilar wafers, improves thermal expansion coefficient matching, and reduces the risk of strain and warping of the photonic platform and/or spacer structures.

### Example Quantum Computing System Comprising a Composite Confinement Apparatus Assembly

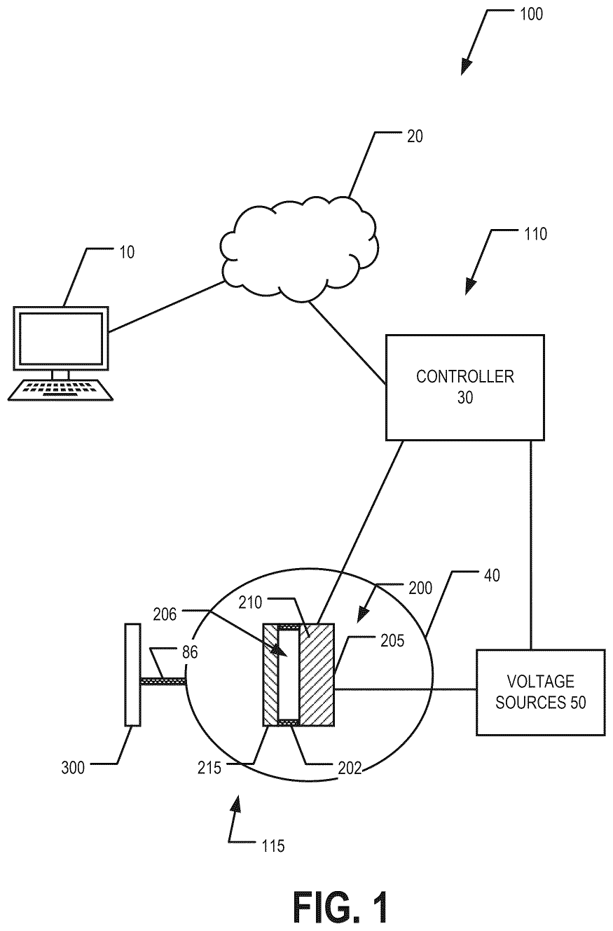

FIG. 1 provides a schematic diagram of an example quantum computing system 100 comprising a composite confinement apparatus assembly 200, in accordance with an example embodiment. In various embodiments, the composite confinement apparatus assembly 200 comprises a confinement apparatus substrate 205 and a photonic platform 215. In various embodiments, the photonic platform 215 and the confinement apparatus substrate 205 are coupled and/or secured in relation to one another via legs and/or spacer structures 202. In various embodiments, a plurality of electrical components that form and/or define a confinement apparatus 210 are formed and/or disposed on the confinement apparatus substrate 205.

In various embodiments, the composite confinement apparatus assembly 200 is disposed within a cryogenic and/or vacuum chamber 40. For example, the confinement apparatus substrate 205, and photonic platform 215 are disposed within the cryogenic and/or vacuum chamber 40.

In various embodiments, the confinement apparatus 210 and/or confinement apparatus substrate 205 define an apparatus plane. In various embodiments, the photonic platform 215 defines a platform plane. In various embodiments, the platform plane is parallel to the apparatus plane but not coplanar with the apparatus plane. For example, the platform plane and the apparatus plane are separated by a set distance h. In various embodiments, the set distance h is in a range of 5 microns to 500 microns. In an example embodiment, the set distance h is two to five times the height at which the confinement apparatus 210 is configured to confine the quantum objects above a surface of the confinement apparatus 210 configured to face the photonic platform 215.

An open space between the confinement apparatus substrate and the photonic platform defines a confinement apparatus volume 206. The confinement regions generated through the operation of the electrical components of the confinement apparatus 210 (which are formed on the confinement apparatus substrate 205) generate confinement regions that are disposed within the confinement apparatus volume 206 defined between the confinement apparatus and the photonic platform. For example, the object locations defined at least in part by the confinement apparatus are within the confinement apparatus volume defined between the confinement apparatus and the photonic platform.

In various embodiments, the quantum computing system 100 comprises a signal management system. In various embodiments the signal management system comprises the photonic platform 215. For example, the photonic platform 215 comprises one or more photonic components that are used to control parameters (e.g., wavelength, focus, polarization, phase, direction of propagation, and/or intensity) of and/or provide one or more manipulation signals (e.g., electromagnetic signals configured to cause a controlled evolution of the quantum state of a quantum object) to respective object locations. In various embodiments, the signal management system further comprises one or more optical components formed and/or disposed on and/or in the confinement apparatus substrate 205. In an example embodiment, the signal management system includes various optical elements, manipulation sources (e.g., lasers, masers, microwave sources, etc.) 300 and/or the like that are located external to the cryogenic and/or vacuum chamber 40. For example, the one or more optical elements and/or manipulation sources located external to the cryogenic and/or vacuum chamber 40 are coupled to respective beam paths defined at least in part by the photonic components of the photonic platform 215 and/or optical components of the confinement apparatus substrate 205 via optical fibers 86 and/or free space optics, in various embodiments.

In various embodiments, the quantum computing system 100 comprises a computing entity 10 and a quantum computer 110. In various embodiments, the quantum computer 110 comprises a controller 30 and a quantum processor 115. In various embodiments, the quantum processor comprises a cryogenic and/or vacuum chamber 40 enclosing composite confinement apparatus assembly 200 (e.g., an ion trap-photonic platform assembly), one or more optical elements and/or manipulation sources 300 that are external to the cryogenic and/or vacuum chamber 40, one or more voltage sources 50 configured to provide voltage signals to the electrical components of the composite confinement apparatus assembly 200. In various embodiments the quantum processor 115 further includes one or more photodetectors configured for detecting optical signals generated by quantum objects confined at respective object locations, magnetic field generators configured to for generating a magnetic field and/or magnetic field gradient (e.g., desired magnetic field and/or magnetic field gradient) at respective object locations, and/or the like.

In various embodiments, the cryogenic and/or vacuum chamber 40 is a temperature and/or pressure-controlled chamber. For example, the quantum computing system 100 may comprise vacuum and/or temperature control components that are operatively coupled to the cryogenic and/or vacuum chamber 40.

In various embodiments, the quantum computer 110 comprises one or more voltage sources 50. For example, the voltage sources 50 may comprise a plurality of voltage drivers and/or voltage sources and/or at least one radio frequency (RF) driver and/or voltage source. The voltage sources 50 may be electrically coupled to the corresponding electrical components 212 (e.g., electrodes) of the confinement apparatus 210, in an example embodiment. For example, the electric and/or electromagnetic field formed at least in part by applying the voltage signals generated by the voltage source 50 to the electrical components 212 of the confinement apparatus 210 causes and/or forms the confinement region(s) of the confinement apparatus.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control and/or be in electrical communication with the voltage sources 50, cryogenic system and/or vacuum system controlling the temperature and/or pressure within the cryogenic and/or vacuum chamber 40, manipulation sources 60, photodetectors, and/or other systems controlling various environmental conditions (e.g., temperature, pressure, magnetic field, and/or the like) within the cryogenic and/or vacuum chamber 40 and/or configured to manipulate and/or cause a controlled evolution of quantum states of one or more quantum objects confined by the confinement apparatus. For example, the controller 30 may cause a controlled evolution of quantum states of one or more quantum objects within the confinement apparatus to execute a quantum circuit and/or algorithm. For example, the controller 30 may cause a reading procedure to be performed, possibly as part of executing a quantum circuit and/or algorithm. In various embodiments, the quantum objects confined within the confinement apparatus are used as qubits of the quantum processor 115 and/or quantum computer 110.

### Example Composite Confinement Apparatus Assembly

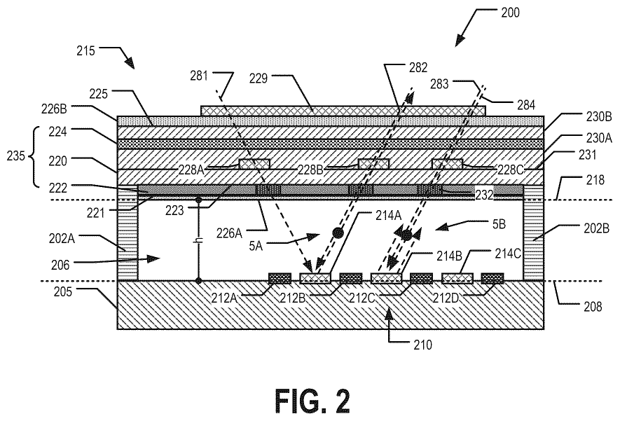

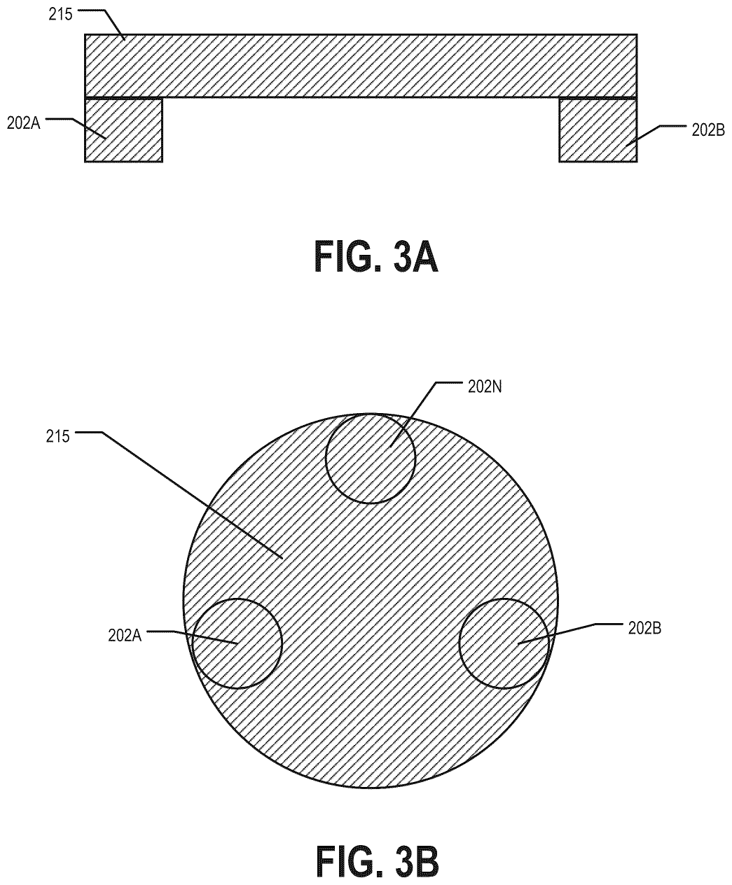

FIG. 2 provides a schematic cross-section view of an example embodiment of a composite confinement apparatus assembly 200. FIG. 3A provides a schematic side cross section view of a photonics apparatus, according to an example embodiment and FIG. 3B provides a schematic bottom cross section view of a photonics apparatus, according to an example embodiment. The composite confinement apparatus assembly 200 includes a confinement apparatus 210 formed on a confinement apparatus substrate 205 and a photonics apparatus comprising a photonic platform 215 and spacer structures 202 (e.g., 202A, 202B). The photonic platform 215 and the confinement apparatus substrate 205 are coupled to one another and/or secured into relationship with one another via spacer structures 202.

In various embodiments, the confinement apparatus 210 and/or confinement apparatus substrate 205 define an apparatus plane 208. In various embodiments, the photonic platform 215 defines a platform plane 218. In various embodiments, the platform plane 218 is parallel to the apparatus plane 208, but not coplanar with the apparatus plane 208. For example, the platform plane 218 and the apparatus plane 208 are separated by a set distance h. The relationship between the platform plane 218 and the apparatus plane 208 is controlled and/or maintained by the legs or spacer structures 202. For example, the set distance h and/or the parallel relationship between the platform plane 218 and the apparatus plane 208 is controlled and/or maintained by the legs and/or spacer structures 202. A confinement apparatus volume 206 is defined and/or disposed between the confinement apparatus substrate 205 and the photonic platform 215. The confinement regions generated through the operation of the electrical components 212 (e.g., 212A, 212B, 212C, 212D) of the confinement apparatus 210 (which are formed on the confinement apparatus substrate 205) generate confinement regions that are disposed within the confinement apparatus volume 206 defined between the confinement apparatus 210 and the photonic platform 215. For example, the object locations 5 (e.g., 5A, 5B) defined at least in part by the confinement apparatus 210 are within the confinement apparatus volume 206 defined between the confinement apparatus 210 and the photonic platform 215.

In various embodiments, the composite confinement apparatus assembly 200 comprises a confinement apparatus 210. The confinement apparatus 210 comprises a plurality of electrical components 212 (e.g., 212A, 212B, 212C, 212D) such as electrodes, in an example embodiment, that are configured to generate a confining potential that defines one or more confinement regions of the confinement apparatus 210. In various embodiments, the plurality of electrical components 212 of the confinement apparatus 210 are formed and/or disposed on a confinement apparatus substrate 205. For example, the controller 30 may control the voltage sources 50 to provide electrical signals to the electrical components 212 of the confinement apparatus 210 such that the electrical components 212 generate a confining potential. The confining potential is configured to confine a plurality of quantum objects within one or more confinement regions defined by the confinement apparatus 210 and disposed within the confinement apparatus volume 206 between the confinement apparatus substrate 205 and the photonic platform 215. In various embodiments, the electrical components 212 and/or confining potential are configured to define a plurality of object locations within the confinement region(s) and/or confinement apparatus volume 206.

In various embodiments, the voltage sources 50 provide respective electrical signals to the respective electrical components 212 (e.g., electrodes) of the confinement apparatus 210, such that a confining potential is formed. Based on the contours and time evolution of the confining potential (controlled by the controller 30 via controlling the operation of the voltage sources 50) one or more quantum objects are confined at respective object locations 5, moved between respective object locations, and/or the like. When a quantum object is located at an object location, one or more functions (e.g., quantum computing functions) may be performed on the quantum object.

In various embodiments, one or more optical components 214 (e.g., 214A, 214B, 214C) are formed on the confinement apparatus substrate 205. In various embodiments, the one or more optical components 214 comprise flat optics (e.g., metasurfaces, DOEs), guided mode photonics (e.g., waveguides), microfabricated lenses, and/or the like. For example, in various embodiments, the photonic components and/or optical components of the signal management system comprise one or more DOEs, passive metasurfaces, active metasurfaces, optical modulators, low loss waveguides, amplifiers, on-chip lasers, photodetectors, grating couplers, beam splitters, edge couplers, optical local oscillators, tapers, reference cavities, optical sinks, light absorbing structures, anti-reflection coatings, optical routing elements, resonant structures, and/or the like. In various embodiments, the one or more optical components 214 are configured to control parameters (e.g., wavelength, focus, polarization, phase, direction of propagation, and/or intensity) and/or provide manipulation signals to respective object locations. For example, an optical component 214 is associated with a respective object location 5 such that the optical component 214 is part of an optical path for providing a respective manipulation signal to the respective object location to cause a respective function to be performed one or more quantum objects disposed at the respective object location.

The composite confinement apparatus assembly 200 further includes a photonic platform 215. The photonic platform 215 comprises photonic components. In the illustrated embodiments, the photonic components of the photonic platform 215 include cladded photonic components (e.g., 228A, 228B, 228C) and exposed photonic components 229. In various embodiments, the cladded photonic components include one or more waveguide layers 224. In various embodiments, the one or more photonic components (e.g., cladded photonic components 228 and/or exposed photonic components 229) comprise one or more diffractive optical elements, passive metasurfaces, active metasurfaces, optical modulators, low loss waveguides, amplifiers, on-chip lasers, photodetectors, grating couplers, beam splitters, edge couplers, optical local oscillators, tapers, reference cavities, optical sinks, light absorbing structures, anti-reflection coatings, optical routing elements, resonant structures, and/or the like. In various embodiments, the one or more photonic components are configured to control parameters (e.g., wavelength, focus, polarization, phase, direction of propagation, and/or intensity) and/or provide manipulation signals to respective object locations. For example, a photonic component is associated with a respective object location 5 such that the photonic component is part of an optical path for providing a respective manipulation signal to the respective object location to cause a respective function to be performed one or more quantum objects disposed at the respective object location.

In various embodiments, the photonic platform 215 comprises a photonic platform substrate 220. In various embodiments, the photonic platform substrate 220 is transparent to light and/or electromagnetic signals characterized by a wavelength within a particular wavelength range. In various embodiments, the manipulation signals provided to the respective object locations are characterized by wavelengths within the particular wavelength range. For example, the photonic platform substrate 220 is transparent to the manipulation signals, in various embodiments. In various embodiments, one or more waveguides, waveguide layers 224, and/or cladded photonic components 228 are formed on the photonic platform substrate 220. Cladding layers 230 (e.g., 230A, 230B) may then be deposited and/or formed on the one or more waveguides, waveguide layers 224, and/or cladded photonic components 228 so as to clad the one or more waveguides, waveguide layers 224, and/or cladded photonic components 228. In various embodiments, several alternating layers of waveguides, waveguide layers 224, and/or cladded photonic components 228 and corresponding cladding layers 230 may be sequentially formed on the photonic platform substrate 220 to form component-integrated platform substrate 235. In various embodiments, the layers of cladding layers 230 and the photonic platform substrate 220 are formed of the same material and/or material that has similar optical properties (e.g., similar refractive indices, absorption coefficients, and/or transmission coefficients for manipulation signals characterized by wavelengths within the particular wavelength range).

For example, in the illustrated example embodiment, a plurality of cladded photonic components 228 are formed on a first surface 231 of the photonic platform substrate 220. The first surface 231 of the photonic platform substrate 220 is configured to face away from the confinement apparatus substrate 205, in the illustrated embodiment. A first cladding layer 230A is then deposited and/or formed on the first surface 231 of the photonic platform substrate 220 and the cladded photonic components 228 formed thereon. A waveguide layer 224 is formed on the first cladding layer 230A and a second cladding layer 230B is formed on the waveguide layer 224. Various layers of waveguides and/or other photonic components (e.g., flat optics, guided mode photonics, microfabricated lenses) and corresponding cladding layers may be formed on the first surface 231 of the photonic platform substrate 220, as appropriate for the application, to form the component-integrated platform substrate 235.

In various embodiments, the photonic platform substrate 220 and/or cladding layer(s) 230 comprises glass, sapphire, or fused quartz. Various other materials may be used for forming the photonic platform substrate 220 and/or cladding layer 230, in various embodiments, as appropriate for the application.

In various embodiments, the cladded photonic components 228, waveguides, and/or waveguide layers 224 are configured to cause respective manipulation signals to be incident on respective object locations 5 defined by the confinement apparatus 210. In various embodiments, the cladded photonic components 228, waveguides, and/or waveguide layers 224 are configured to control parameters (e.g., wavelength, focus, polarization, phase, direction of propagation, and/or intensity) of respective manipulation signals provided to respective object locations 5.

In various embodiments, the cladded photonic components 228, waveguides, waveguide layers 224, and cladding layers are formed on the second surface 223 of the photonic platform substrate 220 to form the component-integrated platform substrate 235 (e.g., rather than the first surface 231). In various embodiments, respective cladded photonic components 228, waveguides, waveguide layers 224, and cladding layers are formed on both the first surface 231 and the second surface 223 of the photonic platform substrate 220 to form the component-integrated platform substrate 235.

In various embodiments, an anti-reflection coating 226B is applied to the first surface 225 of the component-integrated platform substrate 235. For example, the anti-reflection coating 226B may be applied, formed, and/or deposited on the first surface 225 of the component-integrated platform substrate 235. In various embodiments, the anti-reflection coating 226B is engineered to minimize and/or reduce the reflection of light off of the first surface 225. For example, the anti-reflection coating 226B is configured, engineered, and/or designed, to increase and/or maximize the transmission coefficient across the first surface 225. In various embodiments, the first surface 225 of the component-integrated platform substrate 235 is configured to face away from the confinement apparatus substrate 205.

In various embodiments, exposed photonic components 229 are disposed on the first surface 225 of the component-integrated platform substrate 235. For example, the exposed photonic components 229 are formed on the anti-reflection coating 226B in an example embodiment. In various embodiments, the exposed photonic components 229 include one or more of diffractive optical elements, passive metasurfaces, active metasurfaces, optical modulators, low loss waveguides, amplifiers, on-chip lasers, photodetectors, grating couplers, beam splitters, edge couplers, optical local oscillators, tapers, reference cavities, optical sinks, light absorbing structures, optical routing elements, resonant structures, and/or the like. For example, in various embodiments, the exposed photonic components 229 include one or more metasurfaces, a metasurface array, one or more lenses, a lenslet array, and/or the like. In an example embodiment, the exposed photonic component 229 is configured to couple manipulation signals into the photonic platform 215.

A second surface 223 of the photonic platform substrate 220 and/or component-integrated platform substrate 235 is configured to face the confinement apparatus substrate 205. In various embodiments, a conductive layer 222 is disposed, deposited, and/or formed on the second surface 223 of the photonic platform substrate 220 and/or component-integrated platform substrate 235. In various embodiments, the conductive layer 222 comprises an electrically conductive material. In various embodiments, the conductive layer 222 is configured to be held at a fixed electric potential. For example, the conductive layer 222 may be in electrical communication with a ground and/or a voltage source configured to cause the conductive layer 222 to be held at a fixed electric potential.

In various embodiments, at least one or more sections of the conductive layer 222 are transparent for electromagnetic radiation characterized by wavelengths within the particular wavelength range. In various embodiments, the conductive layer 222 is a transparent conductive film and/or layer. For example, the conductive layer 222 may be formed of indium tin oxide (ITO) or another transparent conductive material. In various embodiments, the conductive layer 222 comprises one or more transparent sections 232. For example, the conductive layer 222 may be formed of a non-transparent conductive material. The one or more transparent sections 232 may be windows opened in the non-transparent conductive material (e.g., via etching, masked or lithographic deposition of the non-transparent conductive material, and/or the like). In various embodiments, the one or more transparent sections 232 are formed of a transparent conductive material, are empty openings in the conductive material of the conductive layer 222, and/or the like.

In various embodiments, a confinement apparatus-facing surface 221 of the conductive layer 222 (and/or portions thereof) has anti-reflective characteristics. In various embodiments, an anti-reflection coating 226A is applied, deposited, and/or disposed on the confinement apparatus-facing surface 221 of the conductive layer 222. In various embodiments, the anti-reflection coating 226A is engineered to minimize and/or reduce the reflection of light off of the confinement apparatus-facing surface 221. For example, the anti-reflection coating 226A is configured, engineered, and/or designed, to increase and/or maximize the transmission coefficient across the confinement apparatus-facing surface 221. In various embodiments, the confinement apparatus-facing surface 221 is configured to face the confinement apparatus substrate 205.

In various embodiments, the conductive layer 222 comprises a plurality of patterned electrodes. For example, in an example embodiment, the conductive layer 222 comprises a plurality of patterned electrodes configured to form a confinement apparatus. For example, the conductive layer 222 may comprise a plurality of patterned electrodes configured to form a secondary confinement apparatus that is independent (or largely independent) of the confinement apparatus 210 formed on the confinement apparatus substrate 205. For example, the conductive layer 222 may comprise a plurality of patterned electrodes configured to form, in coordination with the electrode components 212 formed on the confinement apparatus 210 to form a three-dimensional (3D) confinement apparatus.

The photonic components (e.g., cladded photonic components 228, exposed photonic components 229, and/or other photonic components) of the photonic platform 215 are configured to provide various manipulation signals to respective object locations 5 defined at least in part by the confinement apparatus 210. FIG. 2 illustrates two example strategies for providing various manipulation signals to respective object locations 5.

For example, two manipulation signals are provided such that the manipulation signals are co-axial and counter-propagating when they are incident on the first object location 5A during an overlapping time period. The first manipulation signal 281 and the second manipulation signal 282 are provided during an overlapping time period such that the first manipulation signal 281 and the second manipulation signal 282 are both incident on the first object location 5A during a particular time window. For example, a first manipulation signal 281 is provided to the photonic platform 215 such that the first manipulation signal 281 is conditioned (e.g., has one or more parameters thereof controlled) by the exposed photonic component 229 and the first cladded photonic component 228A. The first manipulation signal 281 is then reflected and/or further conditioned by optical component 214A. A second manipulation signal 282 is provided to the photonic platform 215 such that the second manipulation signal 282 is conditioned (e.g., has one or more parameters thereof controlled) by the exposed photonic component 229 and the second cladded photonic component 228B. The first manipulation signal 281 and the second manipulation signal 282 pass through the first object location 5A such that the first manipulation signal 281 and the second manipulation signal are co-axial but propagating in opposite directions. In various embodiments, such a configuration may be used to perform a two-qubit gate and/or other quantum logical operation at the first object location 5A. For example, the co-axial counter-propagating (reflected) first manipulation signal 281 and the second manipulation signal 282 may be used to perform a two-qubit gate and/or other quantum logical operation at the first object location 5A.

In another example, at a second object location 5B, a third manipulation signal 283 and a fourth manipulation signal 284 are provided along a common optical path to provide coaxial counter-propagating manipulation signals at the second object location 5B. The third manipulation signal 283 and the fourth manipulation signal 284 are provided during an overlapping time period such that the third manipulation signal 283 and the fourth manipulation signal 284 are both incident on the second object location 5B during a particular time window. For example, the third manipulation signal 283 and the fourth manipulation signal 284 are both provided to the photonic platform 215 such that the third manipulation signal 283 and the fourth manipulation signal 284 are conditioned (e.g., have one or more parameters thereof controlled) by the exposed photonic component 229 and the third cladded photonic component 228C. The third manipulation signal 283 and the fourth manipulation signal 284 are reflected and/or further conditioned by a second optical component 214B. The reflected third manipulation signal 283 and the reflected fourth manipulation signal 284 pass back through the second object location 5B to provide the co-axial counter-propagating manipulation signals (e.g., the third manipulation signal 283 interacting with the reflected fourth manipulation signal and the fourth manipulation signal 284 interacting with the reflected third manipulation signal). For example, in an example embodiment, the second optical component 214B is a retroreflector. In various embodiments, such a configuration may be used to perform a two-qubit gate and/or other quantum logical operation at the second object location 5A. For example, the co-axial counter-propagating third manipulation signal and reflected fourth manipulation signal and the co-axial and counter-propagating reflected third manipulation signal and the fourth manipulation signal may be used to perform a two-qubit gate and/or other quantum logical operation at the second object location 5B. In an example embodiment, wherein the second optical component 214B is a retroreflector, the co-axial and counter-propagating reflected third manipulation signal and the fourth manipulation signal generate a phase-stable interference pattern.

In various embodiments, the composite confinement apparatus assembly 200 further includes optical sinks. For example, the photonic platform 215 may include one or more photonic platform sinks configured to act as optical sinks. In another example, the confinement apparatus substrate 205 includes one or more apparatus substrate sinks configured to act as optical sinks. For example, the optical sinks of the composite confinement apparatus assembly 200 are configured to enable and/or facilitate removal of and/or permit the exiting of photons from confinement apparatus volume 206 disposed between the photonic platform 215 and the confinement apparatus substrate 205.

### Example Methods of Fabricating a Photonics Apparatus

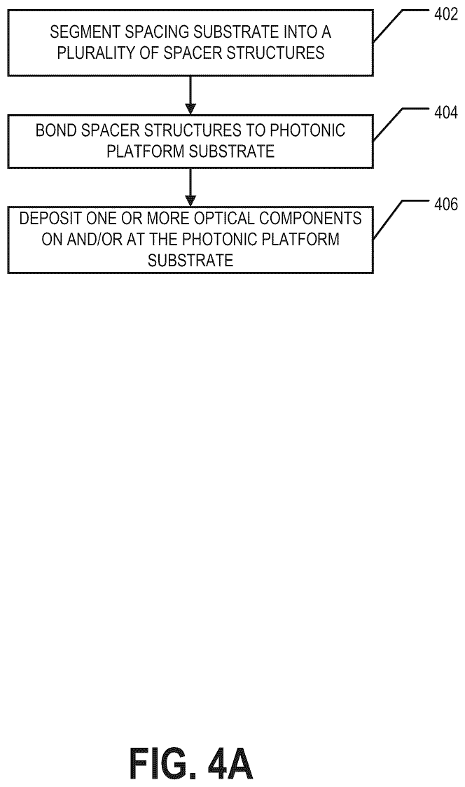

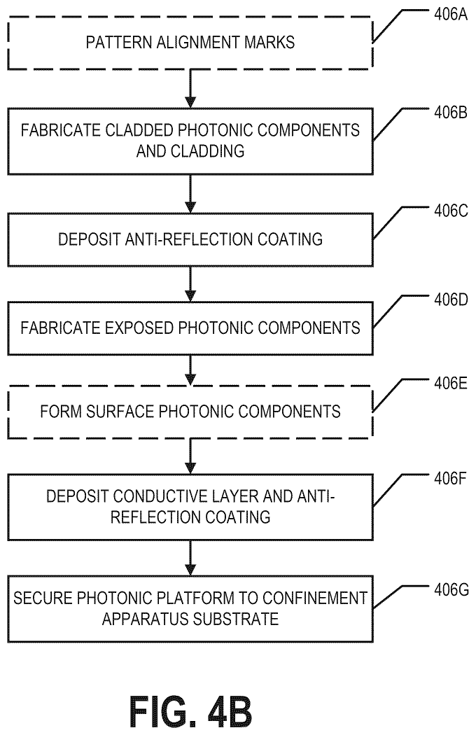

FIG. 4A provides a flowchart illustrating an example method for fabrication of a photonics apparatus 500, according to an example embodiment. Starting at step/operation 402, in an example embodiment, a spacer substrate 504 (e.g., spacer wafer) is segmented into a plurality of spacer structures 202A-N (e.g., also referred to herein as spacer supports). In various embodiments, the spacer substrate 504 is a pre-qualified spacer substrate 504 (e.g., a spacer substrate having the desired properties including, but not limited to, desired thickness and thickness uniformity). For example, the spacer substrate 504 may comprise a pre-qualified spacer substrate having a thickness within a predetermined thickness range and/or a thickness uniformity within a predetermined thickness uniformity range. Such predetermined thickness range and/or thickness uniformity range, for example, may be determined based on the application. In an example embodiment, a pre-qualifying operation is performed prior to segmenting the spacer substrate 504 into the plurality of spacer structures 202A-N. In some embodiments, the thickness and/or thickness uniformity of the spacer substrate 504 is verified or otherwise pre-qualified using one or more of a variety of techniques such as, for example, interferometry. In some embodiments, a single spacer structure (e.g., single continuous spacer structure) is formed from the spacer substrate 504. For example, the spacer substrate 504 may not be segmented into a plurality of spacer structures in some embodiments. In some embodiments, a continuous perimeter wall is formed from the spacer substrate 504. For example, a spacer structure in the form of a continuous perimeter wall may be formed from the spacer substrate 504.

The spacer substrate 504 may comprise any suitable material. Non-limiting examples of materials that can be used to form the spacer substrate 504 include silicon dioxide (SiO2), aluminum oxide (Al2O3), silicon nitride (SiN), silicon carbide (SiC), silicon (Si), silver (Ag), gold (Au), aluminum (Al), platinum (Pt), dielectric reflecting coating (e.g., interference based), and/or the like. For example, the spacer substrate 504 may comprise transparent material (e.g., SiO2, Al2O3, SiN, SiC, Si, and/or the like), reflective material (e.g., Ag, Au, Al, Pt, dielectric reflecting coating, and/or the like), and/or the like. In an example embodiment, the spacer substrate 504 comprises a glass material. In an example embodiment, the spacer substrate 504 comprise a silicon material.

In an example embodiment, the spacer structures 202A-N may have a disk shape. In another example embodiment, the spacer structure 202A-N may have a square shape. In yet another example, the spacer structures 202A-N may have a ring shape. It would be appreciated that the spacer structures 202A-N may have any of a plurality of shapes. For example, the spacer substrate 504 may be segmented into a plurality of spacer structures 202A-N of desired shape. In various embodiments, the plurality of spacer structures 202A-N have the same shape. In an example embodiment, at least a portion of the plurality of spacer structures 202A-N may have different shapes.

In some embodiments, the plurality of spacer structures 202A-N comprise two spacer structures. In some embodiments, the plurality of spacer structures 202A-N comprise three spacer structures. In some embodiments, the plurality of spacer structures 202A-N comprise 10 spacer structures 202A-N. It would be appreciated that the plurality of spacer structures 202A-N may comprise a desired number of spacer structures. For example, the spacer substrate 504 may be segmented into any number of spacer structures based on, for example, the application.

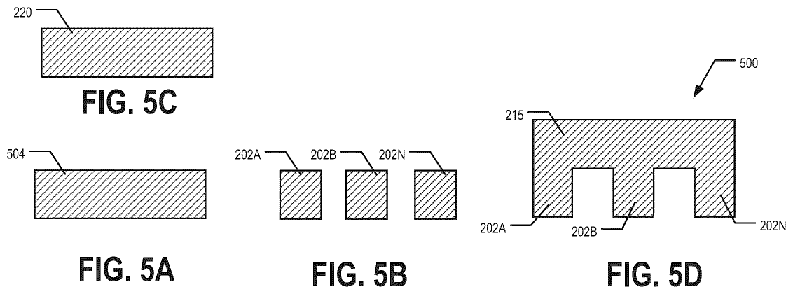

The spacer substrate 504 may be segmented into the plurality of spacer structures 202A-N using any of a variety of segmenting techniques. FIG. 5A illustrates a cross-section example of a spacer substrate 504 prior to segmenting the spacer substrate 504. FIG. 5B illustrates a cross-section after completion of step/operation 402. Specifically, FIG. 5B illustrates a cross-section of a plurality of spacer structures 202A-N segmented from the spacer substrate 504.

Returning to FIG. 4A at step/operation 404, in an example embodiment, the plurality of spacer structures 202A-N are bonded to the photonic platform substrate 220 (e.g., photonic platform wafer). In various embodiments, the plurality of spacer structures 202A-N are bonded to a confinement apparatus-facing surface of the photonic platform substrate 220. In various embodiments, the plurality of spacer structures 202A-N are spaced apart from each other. In various embodiments, the plurality of spacer structures 202A-N are evenly spaced apart. It would be appreciated that in some embodiments, the plurality of spacer structures 202A-N may be unevenly spaced. In some embodiments, a single continuous spacer structure is bonded to the photonic platform substrate 220. For example, as described above, in some embodiments, a single continuous spacer structure may be formed from the spacer substrate 504. This single continuous spacer structure may be bonded to the photonic platform substrate 220. Alternatively, in some embodiments, a single spacer structure from the plurality of spacer structures 202A-N may represent a continuous spacer structure. The single spacer structure, for example, may extend the length of the photonic platform substrate 220 or at least a portion of the length of the photonic platform substrate 220. In some other embodiments, a spacer structure in the form a continuous perimeter wall (e.g., as described above) is bonded to the photonic platform substrate 220.

In an example embodiment, the photonic platform substrate 220 is an un-patterned photonic platform substrate 220 (e.g., a photonic platform substrate that does not yet have photonic components formed thereon or in). In various embodiments, the photonic platform substrate 220 is a pre-qualified photonic platform substrate 220 (e.g., a photonic platform having the desired optical properties including, but not limited to, desired thickness and thickness uniformity). For example, the photonic platform substrate 220 may comprise a pre-qualified photonic platform substrate having a thickness within a predetermined thickness range and/or a thickness uniformity within a predetermined thickness uniformity range. Such predetermined thickness range and/or thickness uniformity range, for example, may be determined based on the application. In an example embodiment, a pre-qualifying operation is performed prior to bonding the spacer structures 202A-N (or single continuous spacer structure or continuous perimeter wall structure in some embodiments) to the photonic platform substrate 220, which may or may not be prior to segmenting the spacer substrate 504 into the plurality of spacer structures 202A-N. In some embodiments, the thickness and/or thickness uniformity of the photonic platform substrate 220 is verified or otherwise pre-qualified using one or more of a variety of techniques such as, for example, interferometry.

The photonic platform substrate 220 may comprise any suitable material. Non-limiting examples of materials that can be used to form the photonic platform substrate 220 include SiO2, Al2O3, SiN, SiC, Si, Ag, Au, Al, Pt, dielectric reflecting coating (e.g., interference based), and/or the like. For example, the photonic platform substrate 220 may comprise transparent material (e.g., SiO2, Al2O3, SiN, SiC, Si, and/or the like), reflective material (e.g., Ag, Au, Al, Pt, dielectric reflecting coating, and/or the like), and/or the like. In an example embodiment, the photonic platform substrate 220 comprises glass material. In an example embodiment, the photonic platform substrate 220 comprises silicon material. In an example embodiment, the photonic platform substrate may comprise a translucent material with respect to light of the particular wavelength range.

In various embodiments, the plurality of spacer structures 202A-N (or single continuous spacer structure or continuous perimeter wall in some embodiments) and the photonic platform substrate 220 may be made of the same material. For example, the spacer substrate 504 and the photonic platform substrate 220 may be formed from the same material. In various embodiments, the plurality of spacer structures 202A-N (or single continuous spacer structure or perimeter wall in some embodiments) and the photonic platform substrate 220 may be made of different materials (e.g., dissimilar materials). For example, the spacer substrate 504 and the photonic platform substrate 220 may be formed from different materials.

The plurality of spacer structures 202A-N (single continuous spacer structure or continuous perimeter wall in some embodiments) may be bonded to the photonic platform substrate 220 using one or more of a variety of techniques such as, but not limited to, optical bonding, silicate bonding, fusion bonding, anodic bonding (e.g., add a thin amorphous silicon layer and performing anodic boding), adhesive bonding, solder bonding, diffusion bonding, eutectic bonding, or metal/metal bonding (e.g., metal to metal bonding), and/or the like. In an example embodiment, the plurality of spacer structures 202A-N (or single continuous spacer structure or continuous perimeter wall in some embodiments) are bonded or otherwise additively deposited (e.g., 3D printed) to the photonic platform substrate 220.

FIG. 5C illustrates an example of an un-patterned photonic platform substrate 220 prior to bonding with the spacer structures 202A-N. FIG. 5D illustrates a cross-section after completion of step/operation 404. Specifically, FIG. 5D illustrates a cross-section of a photonics apparatus comprising a photonic platform 215 and a plurality of spacer structures 202A-N extending from the confinement apparatus-facing surface of the photonic platform substrate 220.

In various embodiments, the plurality of spacer structures 202A-N (or single continuous spacer structure or continuous perimeter wall in some embodiments) are configured for being secured to a confinement apparatus substrate 205 such that a confinement apparatus volume is formed between the photonic platform 215 and the plurality of spacer structures 202A-N (or single continuous spacer structure or continuous perimeter wall in some embodiments). In an example embodiment, the thickness of each spacer structure in a direction perpendicular to the surface of the spacer structure that is bonded to the photonic platform substrate 220 corresponds to a set distance h (e.g., desired set distance h) between the photonic platform 215 and the confinement apparatus substrate 205.

At step/operation 406, in an example embodiment, one or more photonic components and/or other optical components are fabricated on and/or at the photonic platform substrate. In some embodiments, the step/operation 406 may be performed in accordance with the process depicted in FIG. 4B. The process depicted in FIG. 4B configured for fabricating one or more photonic components and/or other optical components on and/or at the photonic platform substrate starts at step/operation 406A.

At step/operation 406A, in an example embodiment, alignment marks are patterned onto the un-patterned photonic platform substrate 220. In an example embodiment, the alignment marks are patterned using a lithographic, masked, or other placement-controlled deposition and/or patterning of one or more surface of the photonic platform substrate 220. In some embodiments, step/operation 406A is an optional step/operation. For example, in some embodiments, alignment marks may not be patterned onto the un-patterned photonic platform substrate 220.

At step/operation 406B, in an example embodiment, one or more cladded photonic components 228 are fabricated on and/or at the photonic platform substrate 220. One or more cladding layers 230 may be deposited. For example, one or more cladded photonic components 228 may be fabricated on an exposed surface of the photonic platform substrate 220. One or more cladding layers 230 may then be deposited thereon to clad the cladded photonic components 228 (e.g., to embed the photonic components within the cladding). In various embodiments, the cladded photonic components 228 may include waveguides and/or waveguide layers 224 in addition to optical sinks, reflective and/or diffractive optics, metasurfaces, and/or the like. In an example embodiment, the fabrication of photonic components and cladding layers may be alternated so as to fabricate a photonic platform 215 comprising a plurality of layers of cladded photonic components 228. In various embodiments, a smoothing or polishing step (e.g., mechanical and/or chemical polishing) may be performed after the deposition of each cladding layer.

At step/operation 406C, in an example embodiment, an anti-reflection coating 226B is deposited and/or applied to a first surface 225 of the component-integrated platform substrate 235. For example, the anti-reflection coating 226B may be applied, formed, and/or deposited on the first surface 225 of the component-integrated platform substrate 235. In various embodiments, the anti-reflection coating 226B is engineered to minimize and/or reduce the reflection of light off of the first surface 225. For example, the anti-reflection coating 226B is configured, engineered, and/or designed, to increase and/or maximize the transmission coefficient across the first surface 225. In various embodiments, the first surface 225 of the component-integrated platform substrate 235 is configured to face away from the confinement apparatus substrate 205.

At step/operation 406D, in an example, embodiment, exposed photonic components 229 are fabricated on the anti-reflection coating 226B. For example, one or more exposed photonic components 229 may be fabricated, formed, and/or mounted to the anti-reflection coating 226B and/or first surface 225 of the component-integrated platform substrate 235. In various embodiments, the exposed photonic component(s) 229 include one or more metasurfaces, a metasurface array, one or more lenses, a lenslet array, and/or the like. In an example embodiment, the exposed photonic component 229 is configured to couple manipulation signals into the photonic platform 215 (e.g., direct the manipulation signals to respect cladded photonic components 228). In an example embodiment, one or more of the exposed photonic components 229 are configured to collimate light emitted by a quantum object disposed at a respective object location and/or otherwise direct the light emitted by a quantum object toward a collection system.

At step/operation 406E, in an example embodiment, one or more surface photonic components are formed on the second surface 223 of the photonic platform substrate 220 and/or component-integrated platform substrate 235. In an example embodiment, the one or more surface photonic components are formed through appropriate depositing and/or etching steps. For example, for surface photonic components that extend out from the second surface 223, material is deposited on the second surface and then patterned to form and/or shape the surface photonic component reflective surface(s) (e.g., desired surface photonic component reflective surface(s)). In another example, for the surface photonic components that are recessed in the second surface, a corresponding portion of the second surface is patterned, etched, and/or shaped to form the surface photonic component reflective surface(s).

In an example embodiment, a reflective coating is applied to the photonic component reflective surface(s). In an example embodiment, the one or more photonic surface photonic components are formed after deposition of the conductive layer 222 on the second surface 223 and/or after deposition of the anti-reflection coating 226A on the confinement apparatus-facing surface 221 of the conductive layer 222. In an example embodiment, the anti-reflection coating 226A and/or conductive layer 222 is removed at the location where the photonic surface component is to be formed and the photonic surface component is then formed in the location where the anti-reflection coating 226A and/or conductive layer 222 was removed.

At step/operation 406F, a conductive layer 222 is deposited on the second surface 223 of the photonic platform substrate 220 and/or component-integrated platform substrate 235. For example, the conductive layer is electrically conductive and is either transparent to light characterized by wavelengths within the particular wavelength range or comprises electrically conductive windows that are transparent to light characterized by wavelengths within the particular wavelength range. In an example embodiment, the conductive layer 222 is deposited on the second surface 223 of the photonic platform substrate 220 and/or component-integrated platform substrate 235 and one or more surfaces of the spacer structures 202 (or single continuous spacer structure or continuous perimeter wall in some embodiments). For example, in an example embodiment, the surfaces of the spacer structures (or single continuous spacer structure or continuous perimeter wall in some embodiments) that face the space that will be the confinement apparatus volume 206 may have a conductive layer 222 deposited thereon. In various embodiments, the conductive layer 222 is configured to be grounded and/or held at a fixed electric potential.

In an example embodiment, the conductive layer 222 has anti-reflective properties. In an example embodiment, an anti-reflection coating 226A is deposited and/or applied to the confinement apparatus-facing surface 221. For example, the anti-reflection coating 226A may be applied, formed, and/or deposited on the confinement apparatus-facing surface 221 of the conductive layer 222 and/or component-integrated platform substrate 235. In various embodiments, the anti-reflection coating 226A is engineered to minimize and/or reduce the reflection of light off of the confinement apparatus-facing surface 221. For example, the anti-reflection coating 226A is configured, engineered, and/or designed, to increase and/or maximize the transmission coefficient across the confinement apparatus-facing surface 221. In various embodiments, the confinement apparatus-facing surface 221 of the conductive layer 222 and/or component-integrated platform substrate 235 is configured to face toward the confinement apparatus substrate 205. In an example embodiment, anti-reflection coating 226A is also deposited on one or more surfaces of the spacer structures 202 (e.g., the surfaces of the spacer structures that face in toward what will be the confinement apparatus volume 206).

In an example embodiment, the anti-reflection coating 226A is either not deposited (e.g., using a masking process) and/or removed from the locations where the reflective surfaces are or will be located.

At step/operation 406G, in some embodiments, the photonic platform 215 is secured to the confinement apparatus substrate 205 to form a composite confinement apparatus assembly 200. For example, alignment marks on the photonic platform 215 and/or spacer structures 202 (or single continuous spacer structure or continuous perimeter wall in some embodiments) are aligned with corresponding alignment marks on the confinement apparatus substrate 205. The spacer structures 202 (or single continuous spacer structure or continuous perimeter wall in some embodiments) are then bonded and/or mechanically coupled to the confinement apparatus substrate 205 with the alignment marks in alignment with respective corresponding alignment marks.

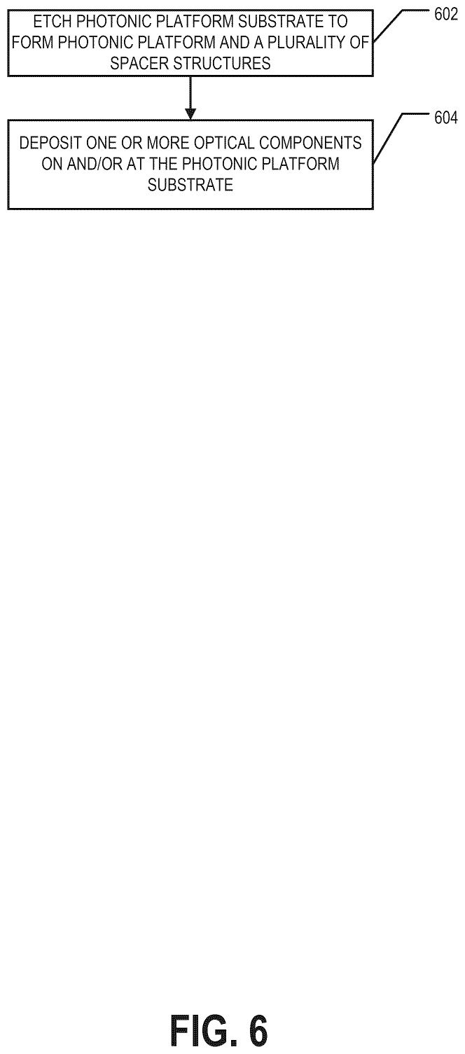

FIG. 6 provides a flowchart illustrating another example method for fabricating a photonics apparatus 700, according to an example embodiment. Starting at step/operation 602, in an example embodiment, a photonic platform substrate 220 is etched to define or otherwise form a photonic platform 215 and a plurality of spacer structures 202A-N. The photonic platform substrate 220 may have height that corresponds to the height (e.g., desired height) of the photonic platform 215 plus the height (e.g., desired height) of the spacer structures 202A-N. In various embodiments, the photonic platform substrate 220 is a pre-qualified photonic platform substrate 220 (e.g., a spacer substrate having the desired properties including, but not limited to, desired thickness and uniformity). For example, the photonic platform substrate 220 may comprise a pre-qualified photonic platform substrate having a thickness within a predetermined thickness range and/or a thickness uniformity within a predetermined thickness uniformity range based on, for example, the application. In an example embodiment, a pre-qualifying operation is performed prior to etching the photonic platform substrate 220. In some embodiments, the thickness and/or thickness uniformity of the photonic platform substrate 220 is verified or otherwise pre-qualified using one or more of a variety of techniques such as, for example, interferometry. In an example embodiment, the thickness of the photonic platform substrate 220 and/or the spacer structures 202A-N are uniform to a level of 100 nm or less.

The photonic platform substrate 220 may comprise any suitable material. Non-limiting examples of materials that can be used to form the spacer substrate 504 include SiO2, Al2O3, SiN, SiC, Si, Ag, Au, Al, Pt, dielectric reflecting coating (e.g., interference based), and/or the like. For example, the photonic platform substrate 220 may comprise transparent material (e.g., SiO2, Al2O3, SiN, SiC, Si, and/or the like), reflective material (e.g., Ag, Au, Al, Pt, dielectric reflecting coating, and/or the like), and/or the like. In an example embodiment, the photonic platform substrate 220 comprises glass material. In an example embodiment, the photonic platform substrate 220 comprises silicon material. In an example embodiment, the photonic platform substrate may comprise a translucent material with respect to light of the particular wavelength range.

In an example embodiment, the spacer structure 202A-N may have a disk shape. In another example embodiment, the spacer structure 202A-N may have a square shape. It would be appreciated that the spacer structures 202A-N may have any of a plurality of shapes. For example, the photonic platform substrate 220 may be etched to define or otherwise form a plurality of spacer structures 202A-N of desired shape. In some embodiments, the plurality of spacer structures 202A-N comprise two spacer structures. In some other embodiments, the plurality of spacer structures 202A-N comprise three spacer structures. It would be appreciated that the plurality of spacer structures 202A-N may comprise a desired number of spacer structures. For example, the photonic platform substrate 220 may be etched to define and/or otherwise form any number of spacer structures 202A-N based on, for example, the application.

The photonic platform substrate 220 may be etched to define a photonic platform 215 and a plurality of spacer structures 202A-N using any of a variety of etching techniques. In various embodiments, the photonic platform substrate 220 may be etched using three-dimensional etching techniques including, but not limited to, femtosecond laser-assisted etching. For example, etching the photonic platform substrate 220 to form the photonic platform 215 and the plurality of spacer structures 202A-N may comprise performing a femtosecond laser-assisted etching. In some embodiments, the photonic platform substrate 220 may be etched using fluid jet polishing. For example, etching the photonic platform substrate 220 to form the photonic platform 215 and the plurality of spacer structures 202A-N may comprise etching via fluid jet polishing.

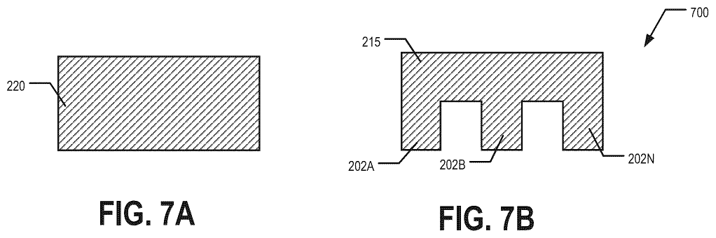

FIG. 7A illustrates a cross-section example of a photonic platform substrate 220 prior to etching the photonic platform substrate 220. FIG. 7B illustrates a cross-section after completion of step/operation 602. Specifically, FIG. 7B illustrates a cross-section of a plurality of spacer structures 202A-N defined by the photonic platform substrate 220 and extending from the confinement apparatus-facing surface of the photonic platform substrate 220.

In various embodiments, the plurality of spacer structures 202A-N are configured for being secured to a confinement apparatus substrate 205 such that a confinement apparatus volume is formed between the photonic platform 215 and the plurality of spacer structures 202A-N. In an example embodiment, the thickness of each spacer structure in a direction perpendicular to the surface of the photonic platform substrate 220 corresponds to a set distance h (e.g., desired set distance h) between the photonic platform 215 and the confinement apparatus substrate 205. For example, in various embodiments, each spacer structure of the plurality of spacer structures 202A-N has a thickness that is substantially equal to the desired distance between the confinement apparatus-facing surface of the photonic platform 215 and the confinement apparatus substrate 205.

At step/operation 604, in an example embodiment, one or more photonic components and/or other optical components are fabricated on and/or at the photonic platform substrate. In some embodiments, the step/operation 604 may be performed in accordance with the process depicted in FIG. 4B and described above.

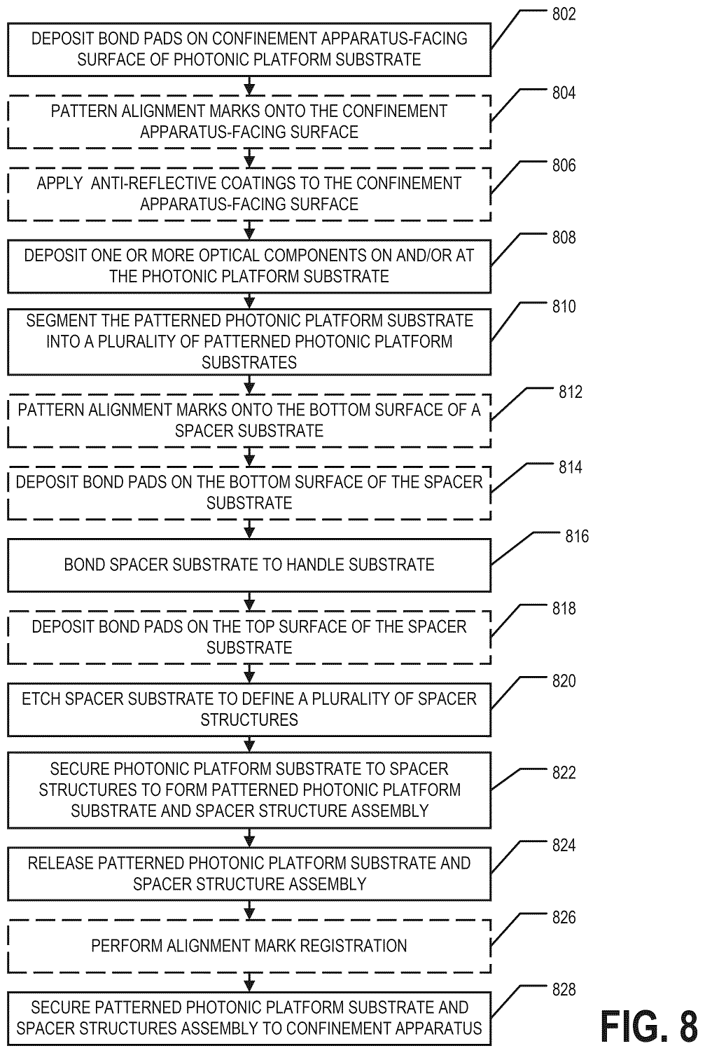

FIG. 8 provides a flowchart illustrating an example method for fabrication of a photonics apparatus 900, according to an example embodiment. Starting at step/operation 802, in an example embodiment, a plurality of bond pads 850A-N are applied, deposited, and/or disposed on a photonic platform substrate 220 (e.g., photonic platform wafer). In various embodiments, the plurality of bond pads 850A-N are applied, deposited, and/or disposed to the confinement apparatus-facing surface 221 of the photonic platform substrate 220. The confinement apparatus-facing surface 221 may be a bottom surface of the photonic platform substrate 220. In various embodiments, the plurality of bond pads 850A-N are spaced apart from each other. In some embodiments, the plurality of bond pads 850A-N are evenly spaced apart. In some embodiments, the plurality of bond pads 850A-N are unevenly spaced apart. The plurality of bond pads may be applied, deposited, and/or disposed using any of a variety of bonding techniques.

In the example embodiment of FIG. 8, the photonic platform substrate 220 is an un-patterned photonic platform substrate 220 (e.g., a photonic platform substrate that does not yet have photonic components formed thereon or in). In various embodiments, the photonic platform substrate 220 is a pre-qualified photonic platform substrate 220 (e.g., a photonic platform having the desired optical properties including, but not limited to, desired thickness and thickness uniformity). For example, the photonic platform substrate 220 may comprise a pre-qualified photonic platform substrate having a thickness within a predetermined thickness range and/or a thickness uniformity within a predetermined thickness uniformity range based on, for example, the application. In an example embodiment, a pre-qualifying operation is performed prior to applying, depositing, and/or disposing the plurality of bond pads 850A-N to the photonic platform substrate 220, In some embodiments, the thickness and/or thickness uniformity of the photonic platform substrate 220 is verified or otherwise pre-qualified using one or more of a variety of techniques such as, for example, interferometry.

The photonic platform substrate 220 may comprise any suitable material. As discussed above, non-limiting examples of materials that can be used to form the photonic platform substrate 220 include SiO2, Al2O3, SiN, SiC, Si, Ag, Au, Al, Pt, dielectric reflecting coating (e.g., interference based), and/or the like. For example, the photonic platform substrate 220 may comprise transparent material (e.g., SiO2, Al2O3, SiN, SiC, Si, and/or the like), reflective material (e.g., Ag, Au, Al, Pt, dielectric reflecting coating, and/or the like), and/or the like. In an example embodiment, the photonic platform substrate 220 comprises glass material. In an example embodiment, the photonic platform substrate 220 comprises silicon material. In an example embodiment, the photonic platform substrate may comprise a translucent material with respect to light of the particular wavelength range.

At step/operation 804, in an example embodiment, alignment marks, such as alignment marks 903 are patterned onto the un-patterned photonic platform substrate 220. In an example embodiment, the alignment marks are patterned using a lithographic, masked, or other placement-controlled deposition and/or patterning of one or more surface of the photonic platform substrate 220. In some embodiments, step/operation 804 is an optional step/operation. For example, in some embodiments, alignment marks may not be patterned onto the un-patterned photonic platform substrate 220.

At step/operation 806, anti-reflection coating is applied, deposited, and/or disposed on the photonic platform substrate 220 (e.g., on the confinement apparatus-facing surface 221 of the photonic platform substrate 220 and/or on the top surface 902 of the photonic platform substrate 220 which is opposite the confinement apparatus-facing surface 221). As discussed above, in various embodiments, the anti-reflection coating is engineered to minimize and/or reduce the reflection of light off of the confinement apparatus-facing surface 221 or the top surface 902. In some embodiments, step/operation 806 is an optional step/operation.

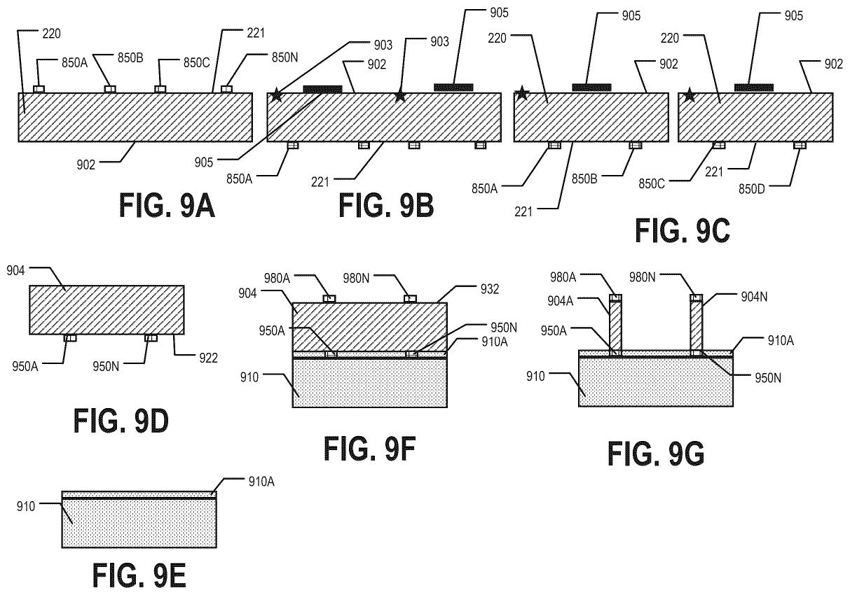

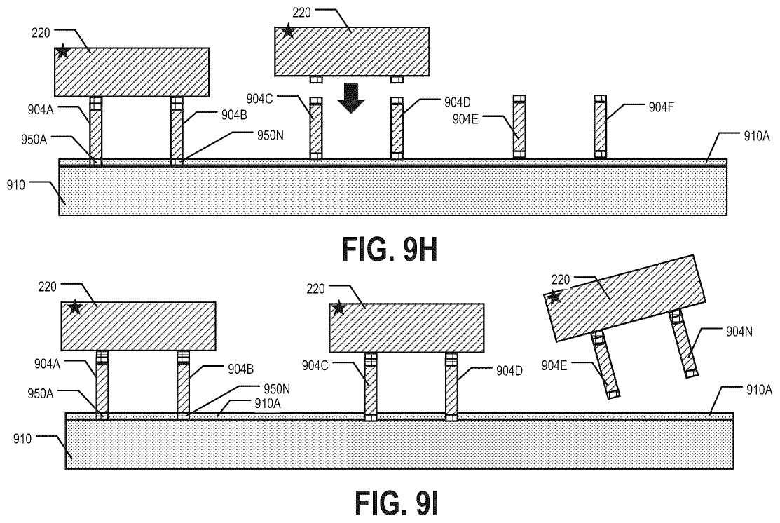

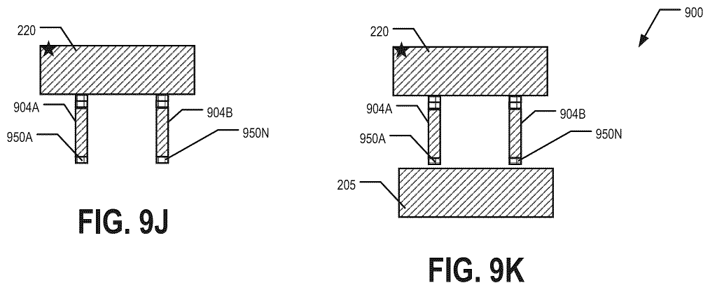

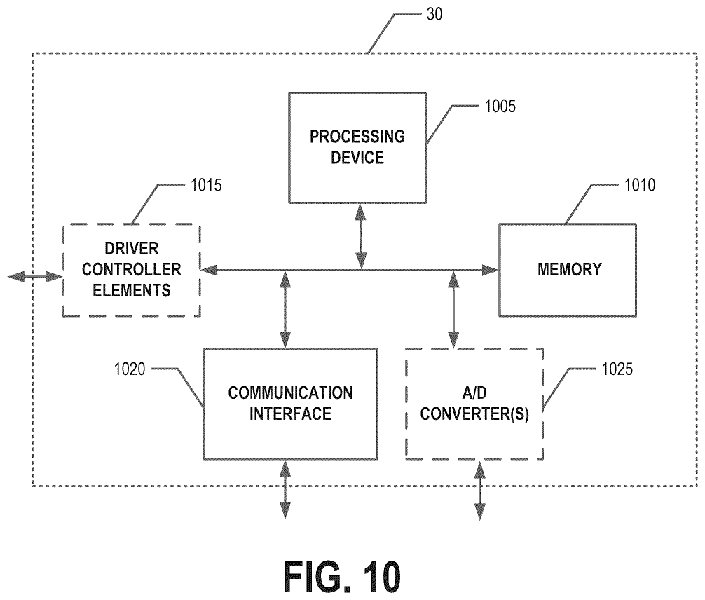

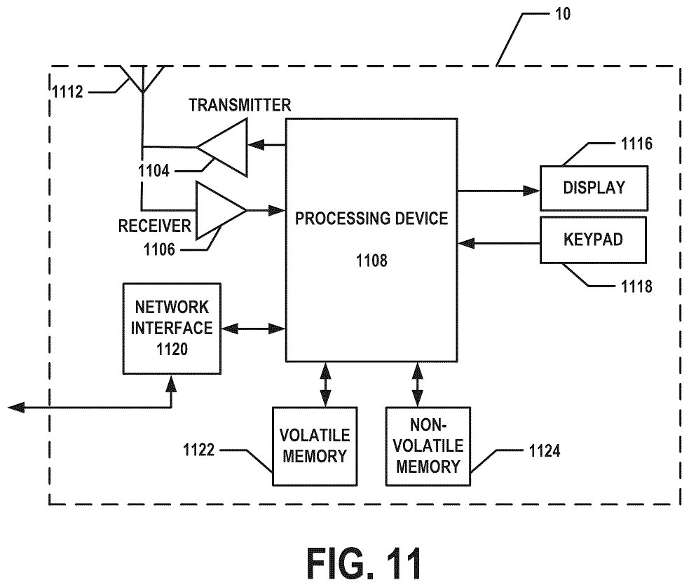

FIG. 9A illustrates an example of an un-patterned photonic platform substrate 220 after completion of step/operation 804 or after completion of step/operation 806 (e.g., in embodiments that include step/operation 806). Specifically, FIG. 9A illustrates a cross-section of a photonic platform substrate 220 comprising a plurality of bond pads 850A-N extending from the confinement apparatus-facing surface 221 of the photonic platform substrate 220.

Returning to FIG. 8, at step/operation 808, in various embodiments, one or more photonic components 905 and/or other optical components are fabricated on and/or at the photonic platform substrate 220 to form a patterned photonic platform substrate (e.g., a photonic platform substrate comprising one or more photonic components and/or other optical components). For example, the photonic components 905 and/or other optical components may be fabricated on the top surface 902 of the photonic platform substrate 220, on the bottom surface (e.g., confinement apparatus-facing surface 221), and/or within the photonic platform substrate 220. The photonic components 905 and/or other optical components may include metasurfaces. In some embodiments, the step/operation 808 may be performed in accordance with the process depicted in FIG. 4B and as discussed above.

FIG. 9B illustrates an example of a patterned photonic platform substrate 220 after step/operation 808. Specifically, FIG. 9B illustrates a cross-section of a patterned photonic platform substrate 220 comprising one or more photonic components 905 and/or other optical components fabricated on and/or at the photonic platform substrate 220. In some embodiments, to fabricate the one or more photonic components 905 and/or other optical components on and/or at the photonic platform substrate 220, the photonic platform substrate 220 is first positioned such that the confinement apparatus-facing surface 221 is facing downward and then the one or more photonic components and/or other optical components are fabricated on and/or at the photonic platform substrate 220. For example, as shown in FIG. 9B, this may include flipping over the photonic platform substrate 220 after step/operation 804 or step/operation 806 (e.g., in embodiments that include step/operation 806).

Returning to FIG. 8, at step/operation 810, in an example embodiment, the patterned photonic platform substrate 220 is segmented into a plurality of patterned photonic platform substrates 220. For example, each segmented photonic platform substrate 220 may be configured for bonding to a spacer structures as further discussed below. In some embodiments, the patterned photonic platform substrates 220 may be stored until the bonding process for the respective confinement apparatus substrate to the spacer structures. In some embodiments, one or more of a variety of techniques (e.g., segmenting techniques) may be leveraged to segment the patterned photonic platform substrate 220 into the plurality of patterned photonic platform substrates 220. Non-limiting examples of such segmenting techniques include dicing, sawing, laser cutting, stealth dicing, or the like.

FIG. 9C illustrates an example of patterned photonic platform substrates 220 after step/operation 810. Specifically, FIG. 9C illustrates a cross-section of patterned photonic platform substrates 220 segmented from a larger patterned photonic platform substrate 220.

Returning to FIG. 8, at step/operation 812, in an example embodiment, alignment marks (e.g., spacer structure alignment marks) are patterned onto the bottom surface 922 of a spacer substrate 904 (e.g., a spacer wafer). In an example embodiment, the spacer structure alignment marks are patterned using a lithographic, masked, or other placement-controlled deposition and/or patterning of one or more surface of the spacer substrate 904. In some embodiments, step/operation 812 is an optional step/operation. For example, in some embodiments, alignment marks may not be patterned onto the bottom surface 922 of the spacer substrate 904.

In various embodiments, the spacer substrate 904 is a pre-qualified spacer substrate 904 (e.g., a spacer substrate having the desired properties including, but not limited to, desired thickness and thickness uniformity). ). For example, the spacer substrate 904 may comprise a pre-qualified spacer substrate having a thickness within a predetermined thickness range and/or a thickness uniformity within a predetermined thickness uniformity range based on, for example, the application. In some embodiments, a pre-qualifying operation is performed to obtain the pre-qualified spacer substrate 904. For example, the pre-qualifying operations may include applying to the spacer substrate 904, one or more of a variety of techniques configured to obtain desired thickness properties for the spacer substrate including, for example, desired thickness and thickness uniformity. In some embodiments, the thickness and/or thickness uniformity of the spacer substrate 904 is verified or otherwise pre-qualified using one or more of a variety of techniques such as, for example, interferometry.

The spacer substrate 904 may comprise any suitable material. Non-limiting examples of materials that can be used to form the spacer substrate 904 include SiO2, Al2O3, SiN, SiC, Si, Ag, Au, Al, Pt, dielectric reflecting coating (e.g., interference based), and/or the like. For example, the spacer substrate 904 may comprise transparent material (e.g., SiO2, Al2O3, SiN, SiC, Si, and/or the like), reflective material (e.g., Ag, Au, Al, Pt, dielectric reflecting coating, and/or the like), and/or the like. In an example embodiment, the spacer substrate 904 comprises a glass material. In an example embodiment, the spacer substrate 904 comprises a silicon material.

At step/operation 814, in an example embodiment, a plurality of bond pads 950A-N are applied, deposited, and/or disposed on the bottom surface 922 of the spacer substrate 904. In various embodiments, the one or more bond pads 950A-N are spaced apart from each other. In some embodiments, the one or more bond pads 950A-N are evenly spaced apart. In some embodiments, the plurality of bond pads 950A-N are unevenly spaced apart. The plurality of bond pads 950A-N may be applied, deposited, and/or disposed using any of a variety of techniques. Additionally, the bond pads 950A-N may be formed of any of a plurality of materials. Non-limiting examples of bond pad materials include copper, aluminum, gold, or the like.

FIG. 9D illustrates an example of a spacer substrate 904 after completion of step/operation 814. Specifically, FIG. 9A illustrates a cross-section of a spacer substrate 904 comprising a plurality of bond pads 950A-N extending from the bottom surface 922 of the spacer substrate 904.

Returning to FIG. 8, at step/operation 816, in an example embodiment, the spacer substrate 904 is bonded to a handle substrate 910 (e.g., a handle wafer) via the plurality of bond pads 950A-N. FIG. 9E illustrates an example of a handle substrate 910. The handle substrate 910 may comprise any suitable material. Non-limiting examples of materials that can be used to form the handle substrate 910 include SiO2, Al2O3, SiN, SiC, Si, Ag, Au, Al, Pt, and/or the like. As shown in FIG. 9E, In various embodiments, the handle substrate 910 includes a release layer 910A. The release layer 910A may comprise any suitable material. Non-limiting examples of material that can be used to form the release layer 910A include adhesives (e.g., temporary adhesives), thin material layers, or the like. In a particular example embodiments, the release layer 910A comprises a thin layer of Au.

Returning to FIG. 8, at step/operation 818, in an example embodiment, a plurality of bond pads 980A-N are applied, deposited, and/or disposed on the top surface 932 of the spacer substrate 904 to form a spacer substrate and handle substrate assembly. In various embodiments, the one or more bond pads 980A-N are spaced apart from each other. In some embodiments, the one or more bond pads 980A-N are evenly spaced apart. In some embodiments, the plurality of bond pads 980A-N are unevenly spaced apart. The plurality of bond pads 980A-N may be applied, deposited, and/or disposed using any of a variety of techniques. Additionally, the bond pads 980A-N may be formed of any of a plurality of materials. Non-limiting examples of bond pad materials include copper, aluminum, gold, or the like. It would be appreciated that in some embodiments, bond pads may be applied to only one of the top surface or the bottom surface of the space substrate. For example, in some embodiments, step/operation 814 or step/operation 818 may not be required or may be an optional step.

FIG. 9F illustrates an example of a spacer substrate and handle substrate assembly after completion of step/operation 818. Specifically, FIG. 9F illustrates a cross-section of a spacer substrate 904 bonded to a handle substrate via bond pads 985A-N on the bottom surface 922 of the spacer substrate 904 and the release layer 910A of the handle substrate 910. FIG. 9F further shows a second set of bond pads 980A-N disposed on the top surface 932 of the spacer substrate 904.

Returning to FIG. 8, at step/operation 820, in an example embodiment, the spacer substrate 904 is etched to define or otherwise form a plurality of spacer structures 904A-N. In an example embodiment, the spacer structure 904A-N may have a disk shape. In another example embodiment, the spacer structures 904A-N may have a square shape. It would be appreciated that the spacer structures 904A-N may have any of a plurality of shapes. For example, the spacer substrate 904 may be etched to define or otherwise form a plurality of spacer structures 904A-N of desired shape. In some embodiments, the plurality of spacer structures 904A-N comprise two spacer structures. In some other embodiments, the plurality of spacer structures 904A-N comprise three spacer structures. It would be appreciated that the plurality of spacer structures 904A-N may comprise a desired number of spacer structures. For example, the spacer substrate 904 may be etched to define and/or otherwise form any number of spacer structures 904A-N based on, for example, the application.

The spacer substrate 904 may be etched to define a plurality of spacer structures 904A-N using any of a variety of etching techniques. In various embodiments, the spacer substrate 904 may be etched using three-dimensional etching techniques including, but not limited to, femtosecond laser-assisted etching. For example, etching the spacer substrate 904 to form the plurality of spacer structures 904A-N may comprise performing a femtosecond laser-assisted etching. In some embodiments, the spacer substrate 904 may be etched using fluid jet polishing. For example, etching the spacer substrate 904 to form the plurality of spacer structures 904A-N may comprise etching via fluid jet polishing. Alternatively or additionally, in an example embodiment, the spacer substrate 904 is etched using glass etching techniques. For example, etching the spacer substrate 904 to form the plurality of spacer structures 904A-N may comprise performing glass etching. The spacer structures 904A-N may have any height and width as desired. For example, the spacer structures 904A-N may have a height within a predetermined heigh range and/or a width within a predetermined width range. Such predetermined height range and/or width range, for example, may be determined based on the application. By way of non-limiting example, in one example embodiment, the spacer structures 904A-N have a height of about 0.2 mm and a width of about 2 mm (e.g., thin pucks).

FIG. 9G illustrates a cross-section example of spacer structures 904-N bonded to a handle substrate 910 after completion of step/operation 820. Specifically, FIG. 9G illustrates a cross-section of a plurality of spacer structures 904A-N formed from a spacer substrate 904.

Returning to FIG. 8, at step/operation 822, in an example embodiment, a patterned photonic platform substrate 220 is bonded and/or secured to a set of spacer structures to form patterned photonic platform substrate and spacer structures assembly. The patterned photonic platform substrate 220 may be bonded to the set of spacer structures using one or more of a variety of techniques such as, but not limited to, optical bonding, silicate bonding, fusion bonding, anodic bonding (e.g., add a thin amorphous silicon layer and performing anodic boding), adhesive bonding, solder bonding, diffusion bonding, eutectic bonding, or metal/metal bonding (e.g., metal to metal bonding), additive bonding, and/or the like.

FIG. 9H illustrates a bonding process of a patterned photonic platform substrate 220 to spacer structures. Specifically, FIG. 9H illustrates a cross-section example of a patterned photonic platform substrate 220 that has been bonded to spacer structures and also illustrates cross-section examples of patterned photonic platform substrates 220 and spacer structures that are in the process of being bonded together.

As shown in the illustrated example of FIG. 9H, each segmented photonic platform substrate 220 may be secured to a respective set of spacer structures. One or more of a variety of bonding techniques may be leveraged to bond or otherwise secure a patterned photonic platform substrate 220 to a set of spacer structures. Non-limiting examples of such bonding techniques include Au to Au bonding, glass to glass bonding, soldering, adhesives, material layers (e.g., other metals, glass to silicon anodic bonding, or the like), or the like. As shown in FIG. 9H, for a respective pair of patterned photonic platform substrate 220 and set of spacer structures, the spacing between the bond pads on the confinement apparatus-facing surface of the patterned photonic platform substrate 220 may be substantially the same as the spacing between the spacer structures in the set of spacer structures such that the bond pads on the confinement apparatus-facing surface of the of the patterned photonic platform substrate 220 align with the bond pads on the top surface of the spacer structures in the set of spacer structures.

Returning to FIG. 8, at step/operation 824, in an example embodiment, the respective patterned photonic platform substrate and spacer structure assembly is released or otherwise removed from the handle substrate 910 via the release layer 910A. For example, the respective patterned photonic platform substrate and spacer structure assembly may be released from the release layer 910A of the handle substrate 910. In some example embodiments, releasing a patterned photonic platform substrate and spacer structure assembly from the handle substrate 910 comprises holding the patterned photonic platform substrate and spacer structure assembly from the top surface using, for example, customized tooling with vacuum suction in safe-to-touch locations and then releasing the patterned photonic platform substrate and spacer structure assembly from the handle substrate 910. In some example embodiments, a single patterned photonic platform substrate and spacer structure assembly may be held with the tooling. For example, holding the patterned photonic platform substrate and spacer structure assembly from the top surface may be done sequentially for each respective patterned photonic platform substrate and spacer structure assembly (e.g., one at a time). In some example embodiments, multiple patterned photonic platform substrate and spacer structure assemblies may be held from the top surface at the same time using a single set of tooling. One or more of a variety of techniques may be leveraged to release a patterned photonic platform substrate and spacer structure assembly from the release layer 910A (e.g., upon safely and firmly holding the patterned photonic platform substrate and spacer structure assembly). Non-limiting examples of such techniques that may be leveraged to release a patterned photonic platform substrate and spacer structure assembly from the release layer 910A include mechanical sheer or other force aided by elevated temperature, laser assisted release, chemical release based on selective removal of the release layer, or the like.

FIG. 9I illustrates a release process of a patterned photonic platform substrate and spacer structure assembly after completion of step/operation 824. Specifically, FIG. 9I illustrates a cross-section example of a patterned photonic platform substrate and spacer structure assembly that has been released from the handle substrate 910 and also illustrates cross-section examples of patterned photonic platform substrate and spacer structure assembly that have not yet been released from the handle substrate 910.

Returning to FIG. 8, at step/operation 826, in an example embodiment, alignment mark registration is performed. For example, performing alignment mark registration may include registering the alignment marks patterned on the top surface of the patterned photonic platform substrate 220 and the bottom portion of the spacer structures. In various embodiments, registering alignment marks comprises accurately measuring the relative alignment. For example, registering the alignment marks patterned on the top surface of the patterned photonic platform substrate 220 and the bottom portion of the corresponding spacer structures may comprise accurately measuring the relative alignment with respect to the patterned photonic platform substrate and the corresponding spacer structures. In some embodiments, the alignment mark registration may be performed prior to releasing the patterned photonic platform substrate and spacer structure assembly from the handle substrate 910. For example, in such embodiments, the alignment mark registration may be performed after step/operation 822. FIG. 9J illustrates a patterned photonic platform substrate and spacer structure assembly after completion of step/operation 826. In some embodiments, step/operation 826 is an optional step/operation. For example, in some embodiments, alignment mark registration may not be performed.

Returning to FIG. 8, at step/operation 828, in an example embodiment, a patterned photonic platform substrate and spacer structure assembly is bonded and/or secured to the confinement apparatus (e.g., confinement apparatus substrate 205 thereof), via the spacer structures, to form a composite confinement apparatus assembly 200. For example, the spacer structures bonded to the patterned photonic platform substrate on one end (e.g., top end) of the spacer structures are bonded to the confinement apparatus at the other end (e.g., bottom end) of the spacer structures. In various embodiments bonding and/or securing the patterned photonic platform substrate and spacer structure assembly to the confinement apparatus includes aligning the alignment marks on the photonic platform substrates and/or spacer structures with corresponding alignment marks on the confinement apparatus substrate. The spacer structures are then bonded and/or mechanically coupled to the confinement apparatus substrate 205 with the alignment marks in alignment with respective corresponding alignment marks. FIG. 9K illustrates a patterned photonic platform substrate and spacer structure assembly secured to a confinement apparatus substrate after completion of operation 828. The patterned photonic platform substrate and spacer structure assembly may bonded and/or secured to the confinement apparatus using one or more of a variety of techniques such as, but not limited, to optical bonding, silicate bonding, fusion bonding, anodic bonding (e.g., add a thin amorphous silicon layer and performing anodic boding), adhesive bonding, solder bonding, diffusion bonding, eutectic bonding, or metal/metal bonding (e.g., metal to metal bonding), additive bonding, and/or the like.

### Technical Advantages

Conventionally, laser beams are provided to positions within an ion trap through the use of external lasers and free space optics configured to provide the laser beams to specific positions within the ion trap. However, the amount of space required for such beam paths, even to provide laser beams to a relatively small number of defined positions of the ion trap, is significant (e.g., a few square meters). Additionally, the accuracy with which the laser beams may be provided to the positions within the ion trap through such conventional means can limit the density of the defined positions of ion trap. Moreover, ion traps are generally utilized within a cryogenic and/or vacuum chamber. As such, the laser beams must be passed through the cryogenic and/or vacuum chamber and any radiation and/or thermal shields therein. Thus, a technical problem exists as to how to provide manipulation signals to a quantum object confinement apparatus that is able to scale with the size and/or dimensions of the quantum object confinement apparatus efficiently and accurately. These technical problems are compounded as the quantum object confinement apparatus is increased in size (e.g., as the number of positions or object locations defined for the quantum object confinement apparatus increases).

Various embodiments provide technical solutions to these technical problems. In particular, in various embodiments, optical elements of the signal management system are incorporated and/or integrated into a composite confinement apparatus assembly. For example, one or more optical elements of the signal management system are disposed within the cryogenic and/or vacuum chamber. For example, the one or more optical elements of the signal management system include photonic components that are part of a photonic platform that is coupled and/or secured into relation with the confinement apparatus and/or confinement apparatus substrate. In some embodiments, the one or more optical elements of the signal management system include optical components disposed on the confinement apparatus substrate. These one or more optical elements include passive and/or active optical elements configured to control various parameters of respective manipulation signals and accurately direct respective manipulation signals to respective object locations. The optical elements may include one or more active optical elements that include photodetectors such as photodiode, photomultiplier, charge-coupled (CCD) sensor, complementary metal oxide semiconductor (CMOS), Micro-Electro-Mechanical Systems (MEMS) sensor, and/or other photodetector. In various embodiments, the use of the photonics apparatus (e.g., photonic platform thereof) reduces the spatial requirements for free space optics beam path configurations, number of cryogenic and/or vacuum chamber pass throughs, and/or the like. Furthermore, the configuration of the composite confinement apparatus assembly of various embodiments reduces the additional technical problems of signal management systems of larger confinement apparatuses. For example, the photonics apparatus is scalable with the confinement apparatus such that the signal management system is configurable for accommodating various numbers and/or arrangements/layouts of object locations. Thus, various embodiments provide technical solutions to technical problems regarding how to provide manipulation signals to an array of object locations defined at least in part by a confinement apparatus such that the manipulation signals are efficiently and effectively provided to the object locations, even when the object locations form a two or three-dimensional array.

Moreover, the photonic platform needs to be precisely spaced from the surface of the confinement apparatus and have a high degree of thickness uniformity and planarity, which otherwise can result in tilted photonic platform and result in wrong angle of direction of the beams from the photonic platform. Moreover, the inventors have found that certain fabrication methods may result in strain and warping. Various embodiments provide technical solutions to these technical problems by compositely or monolithically fabricating a photonics apparatus comprising a photonic platform and spacer structures that define the distance between the photonic platform and the surface of the confinement apparatus. For example, various embodiments form the photonic platform and the spacer structures monolithically from a single material. As another example, various embodiments form or otherwise pattern the spacer structures before securing to the photonic platform. In this regard, by forming the photonic platform and the spacer structures from a single material, various embodiments advantageously provide for matching of thermal expansion coefficients. Further by compositely or monolithically forming the photonic platform and the spacer structures, various embodiments avoid the risk of stress during release etch with bonded dissimilar wafers, improves thermal expansion coefficient matching, and reduces the risk of strain and warping of the photonic platform and/or spacer structures.

### Exemplary Controller

In various embodiments, a composite confinement apparatus assembly 200 is incorporated into a system (e.g., a quantum computer 110) comprising a controller 30. In various embodiments, the controller 30 is configured to control various elements of the system (e.g., quantum computer 110). For example, the controller 30 may be configured to control the voltage sources 50, a cryogenic system and/or vacuum system controlling the temperature and pressure within the cryogenic and/or vacuum chamber 40, manipulation sources 300, cooling system, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the confinement apparatus 210 of the composite confinement apparatus assembly 200. In various embodiments, the controller 30 may be configured to receive signals from one or more photodetectors (e.g., of a collection system and/or the like), calibration sensors, and/or the like.

As shown in FIG. 8, in various embodiments, the controller 30 may comprise various controller elements including processing elements 1005, memory 1010, driver controller elements 1015, a communication interface 1020, analog-digital (A/D) converter elements 1025, and/or the like. For example, the processing elements 1005 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element 1005 of the controller 30 comprises a clock and/or is in communication with a clock.

For example, the memory 1010 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1010 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 1010 (e.g., by a processing element 1005) causes the controller 30 to perform one or more steps, operations, processes, procedures and/or the like described herein for providing manipulation signals to quantum object positions and/or collecting, detecting, capturing, and/or measuring indications of emitted signals emitted by quantum objects located at corresponding object locations 5 of the composite confinement apparatus assembly 200.

In various embodiments, the driver controller elements 1015 may include one or more drivers and/or controller elements each configured to control one or more drivers. In various embodiments, the driver controller elements 1015 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 1005). In various embodiments, the driver controller elements 1015 may enable the controller 30 to operate a voltage sources 50, manipulation sources 300, cooling system, and/or the like. In various embodiments, the drivers may be laser drivers configured to operate one or more manipulation sources 300 to generate manipulation signals; vacuum component drivers; drivers for controlling the flow of current and/or voltage applied to electrodes used for maintaining and/or controlling the trapping potential of the composite confinement apparatus assembly 200 (and/or other drivers for providing driver action sequences to potential generating elements of the optics-integrated confinement apparatus); cryogenic and/or vacuum system component drivers; cooling system drivers, and/or the like. In various embodiments, the controller 30 comprises means for communicating and/or receiving signals from one or more optical receiver components (e.g., photodetectors or collection system). For example, the controller 30 may comprise one or more analog-digital converter elements 1025 configured to receive signals from one or more optical receiver components (e.g., a photodetector of the optics collection system), calibration sensors, and/or the like.

In various embodiments, the controller 30 may comprise a communication interface 1020 for interfacing and/or communicating with a computing entity 10. For example, the controller 30 may comprise a communication interface 1020 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or via one or more wired and/or wireless networks 20.

### Exemplary Computing Entity

FIG. 9 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 9, a computing entity 10 can include an antenna 1112, a transmitter 1104 (e.g., radio), a receiver 1106 (e.g., radio), and a processing element 1108 that provides signals to and receives signals from the transmitter 1104 and receiver 1106, respectively. The signals provided to and received from the transmitter 1104 and the receiver 1106, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 may comprise a network interface 1120 for interfacing and/or communicating with the controller 30, for example. For example, the computing entity 10 may comprise a network interface 1120 for providing executable instructions, command sets, and/or the like for receipt by the controller 30 and/or receiving output and/or the result of a processing the output provided by the quantum computer 110. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 1116 and/or speaker/speaker driver coupled to a processing element 1108 and a touch screen, keyboard, mouse, and/or microphone coupled to a processing element 1108). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 1118 (hard or soft), a touch display, voice/speech or motion interfaces, scanners, readers, or other input device. In embodiments including a keypad 1118, the keypad 1118 can include (or cause display of) the conventional numeric (0-9) and related keys ( #, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 1122 and/or non-volatile storage or memory 1124, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM.

RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### Conclusion

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of fabricating a photonics apparatus for a composite confinement apparatus assembly, the method comprising:
segmenting a spacer substrate to form a plurality of spacer structures; and
bonding the plurality of spacer structures to a photonic platform substrate.

2. The method of claim 1, further comprising fabricating one or more photonics components on and/or in the photonic platform substrate.

3. The method of claim 1, wherein the plurality of spacer structures is bonded to a confinement apparatus-facing surface of the photonic platform substrate.

4. The method of claim 3, wherein the plurality of spacer structures comprise three spacer structures extending from the confinement apparatus-facing surface of the photonic platform substrate.

5. The method of claim 1, wherein the photonic platform substrate and the spacer substrate comprise same material.

6. The method of claim 4, wherein the photonic platform substrate and the spacer substrate each comprise glass material.

7. The method of claim 1, wherein the photonic platform substrate and the spacer substrate comprise different materials.

8. The method of claim 1, wherein the photonic platform substrate comprises glass material and the spacer substrate comprises silicon material.

9. The method of claim 1, wherein the photonic platform substrate comprises a transparent material.

10. The method of claim 1, wherein bonding the plurality of spacer structures to the photonic platform substrate comprises performing at least one of optical bonding, silicate bonding, fusion bonding, anodic bonding, additive deposition of the plurality of spacer structures to the photonic platform substrate, adhesive bonding, solder bonding, diffusion bonding, eutectic bonding, or metal/metal bonding.

11. The method of claim 1, wherein the spacer substrate comprises a pre-qualified spacer substrate having one or more of (i) a thickness within a predetermined thickness range or (ii) a thickness uniformity within a predetermined thickness uniformity range.

12. The method of claim 1, wherein the photonic platform substrate comprises a pre-qualified photonic platform substrate having one or more of (i) a thickness within a predetermined thickness range or (ii) a thickness uniformity within a predetermined thickness uniformity range..

13. A method of fabricating a photonics apparatus for a composite confinement apparatus assembly, the method comprising:
etching a photonic platform substrate to form a photonic platform and a plurality of spacer structures extending from the photonic platform,
wherein:
the plurality of spacer structures are configured for being secured to a confinement apparatus substrate, and
each spacer structure of the plurality of spacer structures has a thickness that is substantially equal to a distance between a confinement apparatus-facing surface of the photonic platform and the confinement apparatus substrate.

14. The method of claim 13, further comprising fabricating one or more photonics components on and/or in the photonic platform substrate.

15. The method of claim 13, wherein the plurality of spacer structures comprise three spacer structures extending from the confinement apparatus-facing surface of the photonic platform substrate.

16. The method of claim 13, wherein etching the photonic platform substrate to form the photonic platform and the plurality of spacer structures comprises performing a femtosecond laser-assisted etching.

17. The method of claim 13, wherein etching the photonic platform substrate to form the photonic platform and the plurality of spacer structures comprises etching via fluid jet polishing.

18. The method of claim 13, wherein the photonic platform substrate comprises silicon dioxide substrate.

19. The method of claim 13, wherein the photonic platform substrate comprises a transparent material.

20. A method of fabricating a photonics apparatus for a composite confinement apparatus assembly, the method comprising:
depositing one or more optical components on and/or at a photonic platform substrate;
etching a spacer substrate to define a plurality of spacer structures;
securing the photonic platform substrate to the plurality of spacer structures; and
securing the photonic platform substrate to a confinement apparatus via the plurality of spacer structures.
